(19) United States
(12) Patent Application Publication
(10) Pub. No.: US 2007/0031757 A1
(43) Pub. Date: Feb. 8, 2007

(54) Positive photosensitive composition and method of pattern formation with the same

(75) Inventors: Kunihiko Kodama, Shizuoka (JP); Kenji Wada, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/497,254

(22) Filed: Aug. 2, 2006

(30) Foreign Application Priority Data
Aug. 2, 2005 (JP) P . 2005-224001

(51) Int. Cl. G03C 1/00

(52) U.S. Cl. 430/270.1

(57) ABSTRACT

A positive photosensitive composition comprising: (A) a compound which generates an acid upon irradiation with actinic rays or a radiation; (B) a resin which decomposes by an action of an acid to come to have an enhanced solubility in an alkaline developing solution; and (F) a solvent, wherein the resin as the component (B) is a resin that has a repeating unit (Ba) having a diamantane structure, and wherein the resin as the component (B) has a weight-average molecular weight of from 3,000 to 30,000 and a dispersity ratio of from 1.1 to 3.0; and a method of pattern formation using the positive photosensitive composition.

### BACKGROUND OF THE INVENTION

1. Field of the Invention

The present invention relates to a positive photosensitive composition for use in steps for producing semiconductors, e.g., IC's, in the production of circuit boards for liquid crystals, thermal heads, etc., and in other photofabrication steps, and to a method of pattern formation with the same. More particularly, the invention relates to a positive photosensitive composition which is suitable for use with an exposure light source emitting, e.g., far ultraviolet having a wavelength of 250 nm or shorter, preferably 220 nm or shorter, or an illuminator emitting electron beams or the like, and to a method of pattern formation with this composition.

2. Description of the Related Art

A chemical amplification type photosensitive composition is a material for pattern formation which functions by the following mechanism. Upon irradiation with actinic rays or a radiation, such as, e.g., far ultraviolet, the composition generates an acid in the exposed areas and undergoes a reaction catalyzed by this acid. As a result, the composition comes to have a difference in solubility in a developing solution between the areas irradiated with the actinic rays or radiation and the unirradiated areas to thereby form a pattern on the substrate.

In the case where a KrF excimer laser is employed as an exposure light source, a resin having a poly(hydroxystyrene) backbone, which shows reduced absorption mainly in a 248-nm region, is used as the main component. Because of this, the composition has high sensitivity and forms satisfactory patterns with high resolution.

It is hence a better system as compared with naphthoquinonediazide/novolak resin systems heretofore in use.

On the other hand, in the case where a light source having a shorter wavelength, e.g., an ArF excimer laser (193 nm), is used as an exposure light source, even the chemical amplification type system has been insufficient because compounds having aromatic groups intrinsically show considerable absorption in a 193-nm region.

Because of this, resists for an ArF excimer laser which contain a resin having an alicyclic hydrocarbon structure have come to be developed. In JP-A-9-73173 is described a resist composition containing an acid-decomposable resin having an adamantane structure. However, with the trend toward finer patterns, it has become necessary to reduce the resist film thickness and resist films are required to have dry-etching resistance. In U.S. Patent Application Laid-Open Specification No. 2005/0074690A is described a resin having repeating units having a diamantane structure. Dry-etching resistance correlates to the carbon density of the resin, and can be improved by increasing the carbon density. However, the resin becomes hydrophobic with increasing carbon density, resulting in deterioration in development defect performance, pattern-forming ability, etc. At present, it is hence extremely difficult to reconcile all performances required of resists. Furthermore, in the case of forming a fine pattern such as those having a line width of 100 nm or smaller, even a resist having excellent resolution has a pattern falling problem that a line pattern formed falls to give defects in device production. There also is a problem concerning line edge roughness performance in line patterns. Improvements in these performances have been desired.

Line edge roughness herein means a phenomenon in which those edges of a resist line pattern which are located at the interface between the resist and the substrate irregularly fluctuate in directions perpendicular to the line direction due to properties of the resist. When this pattern is viewed from right above, the edges appear to be rugged (in the range of about from ±(several nanometers) to ±(tens of nanometers)). This ruggedness is transferred to the substrate by an etching step. Consequently, a high degree of ruggedness is causative of electrical failures, resulting in a reduced yield. For reconciling this line edge roughness performance with other performances, it is necessary to not only design the structures of repeating units but also design the molecular weight and dispersity ratio of the resin and select other monomer components to be used in combination, polymerization method, solvent for the composition, etc.

### SUMMARY OF THE INVENTION

Accordingly, an object of the invention is to provide a positive photosensitive composition which, even when used in forming fine patterns of 100 nm or finer, is excellent in development defects and improved in line edge roughness and pattern falling. Another object of the invention is to provide a method of pattern formation with the composition.

(1) A positive photosensitive composition comprising:

(A) a compound which generates an acid upon irradiation with actinic rays or a radiation;

(B) a resin which decomposes by an action of an acid to come to have an enhanced solubility in an alkaline developing solution; and

(F) a solvent,

wherein the resin as the component (B) is a resin that has a repeating unit (Ba) having a diamantane structure, and

wherein the resin as the component (B) has a weight-average molecular weight of from 3,000 to 30,000 and a dispersity ratio of from 1.1 to 3.0.

(2) The positive photosensitive composition as described in (1) above,

wherein the resin as the component (B) further has a repeating unit having an adamantane structure.

(3) The positive photosensitive composition as described in (1) or (2) above,

wherein the resin as the component (B) further has a non-acid-decomposable repeating unit.

(4) The positive photosensitive composition as described in any of (1) to (3) above,

wherein the solvent (F) comprises an alkylene glycol monoalkyl ether carboxylate.

(5) The positive photosensitive composition as described in (4) above,

wherein the solvent (F) further comprises at least one solvent selected from solvents having at least one functional group selected from a hydroxyl group, a ketone group, a lactone group, an ester group, an ether group and a carbonate group.

(6) The positive photosensitive composition as described in (5) above,

wherein the solvent (F) comprises: propylene glycol monomethyl ether acetate; and at least one solvent selected from propylene glycol monomethyl ether, cyclohexanone, γ-butyrolactone, butyl acetate and ethyl lactate.

(7) The positive photosensitive composition as described in any of (1) to (6) above,

wherein the resin as the component (B) is a resin synthesized by dropping polymerization.

(8) The positive photosensitive composition as described in any of (1) to (7) above,

wherein the compound which generates an acid upon irradiation with actinic rays or a radiation (A) is a compound represented by formula (ZI), (ZII) or (ZIII):

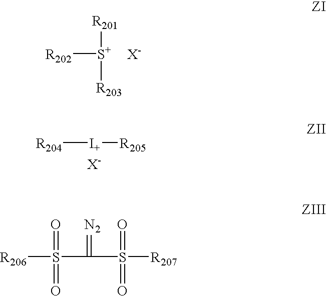

wherein R₂₀₁, R₂₀₂ and R₂₀₃ each independently represents an organic group;

X⁻ represents a non-nucleophilic anion; and

R₂₀₄ to R₂₀₇ each independently represents an aryl group, an alkyl group or a cycloalkyl group.

(9) A method of pattern formation, which comprises:

forming a photosensitive film from a positive photosensitive composition as described in any of (1) to (8) above;

exposing the photosensitive film to light, so as to form an exposed photosensitive film; and

developing the exposed photosensitive film.

### BRIEF DESCRIPTION OF THE DRAWING

FIG. 1 is a diagrammatic view of an experimental apparatus for two-beam interference exposure,

wherein 1 denotes a laser; 2 denotes a diaphragm; 3 denotes a shutter; 4, 5 and 6 denote reflecting mirrors; 7 denotes a condensing lens; 8 denotes a prism; 9 denotes an immersion liquid; 10 denotes a wafer having antireflection film and resist film; and 11 denotes a wafer stage.

### DETAILED DESCRIPTION OF THE INVENTION

Best modes for carrying out the invention will explained below.

With respect to expressions of groups (atomic groups) in this specification, the expressions which include no statement as to whether the groups are substituted or unsubstituted imply both of groups having no substituents and groups having one or more substituents. For example, the term “alkyl group” implies not only an alkyl group having no substituents (unsubstituted alkyl group) but also an alkyl group having one or more substituents (substituted alkyl group).

[1] (A) Compound Generating Acid Upon Irradiation with Actinic Ray or Radiation

The positive photosensitive composition of the invention contains a compound which generates an acid upon irradiation with actinic rays or a radiation (hereinafter referred to also as “acid generator”).

The acid generator to be used can be suitably selected from photoinitiators for cationic photopolymerization, photoinitiators for radical photopolymerization, photodecolorants or optical color changers for dyes, known compounds used in microresist formation or the like which generate an acid upon irradiation with actinic rays or a radiation, and mixtures of two or more thereof.

Examples thereof include diazonium salts, phosphonium salts, sulfonium salts, iodonium salts, imidesulfonates, oximesulfonates, diazodisulfones, disulfones, and o-nitrobenzyl sulfonates.

Also usable are compounds obtained by incorporating any of groups or compounds which generate an acid upon irradiation with actinic rays or a radiation into the main chain or side chains of a polymer. Examples thereof are given in, e.g., U.S. Pat. No. 3,849,137, German Patent 3,914,407, JP-A-63-26653, JP-A-55-164824, JP-A-62-69263, JP-A-63-146038, JP-A-63-163452, JP-A-62-153853, and JP-A-63-146029.

Furthermore, those compounds generating an acid by the action of light which are described in U.S. Pat. No. 3,779,778, European Patent 126,712, etc. can be used.

Preferred of the compounds which generate an acid upon irradiation with actinic rays or a radiation are compounds represented by the following general formulae (ZI), (ZII), and (ZIII).

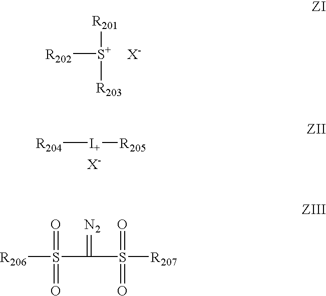

In general formula (ZI),

R₂₀₁, R₂₀₂, and R₂₀₃ each independently represents an organic group.

X⁻ represents a non-nucleophilic anion. Preferred examples thereof include a sulfonic acid anion, carboxylic acid anion, bis(alkylsulfonyl)amide anion, tris(alkylsulfonyl)methide anion, BF₄⁻, PF₆⁻, and SbF₆⁻. Preferred are organic anions containing one or more carbon atoms.

Preferred examples of the organic anions include organic anions represented by the following formulae.

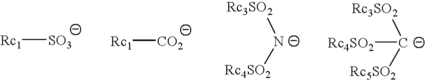

In the general formulae,

Rc₁ represents an organic group.

Examples of the organic group represented by Rc₁ include ones having 1-30 carbon atoms. Preferred examples thereof include alkyl, cycloalkyl, and aryl groups which may have one or more substituents, and further include groups comprising two or more of these groups connected to each other through a single bond or a connecting group such as —O—, —CO₂—, —S—, —SO₃—, or —SO₂N(Rd₁)—.

Rd₁ represents a hydrogen atom or alkyl group.

Rc₃, Rc₄, and Rc₅ each independently represents an organic group.

Examples of the organic groups represented by Rc₃, Rc₄, and Rc₅ include the same organic groups as those shown above as preferred examples of Rc₁. Preferred are perfluoroalkyl groups having 1-4 carbon atoms.

Rc₃ and Rc₄ may be bonded to each other to form a ring.

Examples of the group formed by the bonding of Rc₃ and Rc₄ include alkylene groups, cycloalkylene groups, and arylene groups. Preferred are perfluoroalkylene groups having 2-4 carbon atoms.

Preferred examples of the organic groups represented by Rc₁ and Rc₃ to Rc₅ are: alkyl groups substituted in the 1-position by a fluorine atom or fluoroalkyl group; and a phenyl group substituted by one or more fluorine atoms or fluoroalkyl groups. The presence of one or more fluorine atoms or fluoroalkyl groups enables the acid generated by light irradiation to have an increased acidity to improve sensitivity. Furthermore, the formation of a ring by the bonding of Rc₃ and Rc₄ is preferred because it enables the acid generated by light irradiation to have an increased acidity to improve sensitivity.

In general formula (ZI),

the number of carbon atoms in each of the organic groups represented by R₂₀₁, R₂₀₂, and R₂₀₃ is generally 1-30, preferably 1-20.

Two of R₂₀₁ to R₂₀₃ may be bonded to each other to form a ring structure, which may contain an oxygen atom, sulfur atom, ester bond, amide bond, or carbonyl group therein.

Examples of the group formed by the bonding of two of R₂₀₁ to R₂₀₃ include alkylene groups (e.g., butylene and pentylene).

Examples of the organic groups represented by R₂₀₁, R₂₀₂, and R₂₀₃ include the corresponding groups in the compounds (ZI-1), (ZI-2), and (ZI-3) which will be described later.

A compound having two or more structures represented by general formula (ZI) may also be used. For example, use may be made of a compound having a structure in which at least one of the R₂₀₁ to R₂₀₃ of a compound represented by general formula (ZI) is bonded to at least one of the R₂₀₁ to R₂₀₃ of another compound represented by general formula (ZI).

Preferred examples of the component (ZI) include the compounds (ZI-1), (ZI-2), and (ZI-3) which will be explained below.

Compound (ZI-1) is an arylsulfonium compound represented by general formula (ZI) wherein at least one of R₂₀₁ to R₂₀₃ is an aryl group, i.e., a compound including an arylsulfonium as a cation.

The arylsulfonium compound may be one in which all of R₂₀₁ to R₂₀₃ are aryl groups, or may be one in which part of R₂₀₁ to R₂₀₃ is an aryl group and the remainder is an alkyl or cycloalkyl group.

Examples of the arylsulfonium compound include triarylsulfonium compounds, diarylalkylsulfonium compounds, aryldialkylsulfonium compounds, diarylcycloalkylsulfonium compounds, and aryldicycloalkylsulfonium compounds.

The aryl group of the arylsulfonium compound preferably is an aryl group such as phenyl or naphthyl or a heteroaryl group such as an indole residue or pyrrole residue, and more preferably is phenyl or an indole residue. In the case where the arylsulfonium compound has two or more aryl groups, these aryl groups may be the same or different.

The alkyl group which is optionally possessed by the arylsulfonium compound preferably is a linear or branched alkyl group having 1-15 carbon atoms. Examples thereof include methyl, ethyl, propyl, n-butyl, sec-butyl, and t-butyl.

The cycloalkyl group which is optionally possessed by the arylsulfonium compound preferably is a cycloalkyl group having 3-15 carbon atoms. Examples thereof include cyclopropyl, cyclobutyl, and cyclohexyl.

The aryl, alkyl, and cycloalkyl groups represented by R₂₀₁ to R₂₀₃ may have substituents selected from alkyl groups (e.g., ones having 1-15 carbon atoms), cycloalkyl groups (e.g., ones having 3-15 carbon atoms), aryl groups (e.g., ones having 6-14 carbon atoms), alkoxy groups (e.g., ones having 1-15 carbon atoms), halogen atoms, hydroxyl, and phenylthio. Preferred examples of the substituents are linear or branched alkyl groups having 1-12 carbon atoms, cycloalkyl groups having 3-12 carbon atoms, and linear, branched, or cyclic alkoxy groups having 1-12 carbon atoms. More preferred are alkyl groups having 1-4 carbon atoms and alkoxy groups having 1-4 carbon atoms. Any one of R₂₀₁ to R₂₀₃ may have such a substituent or each of R₂₀₁ to R₂₀₃ may have such a substituent. In the case where R₂₀₁ to R₂₀₃ are aryl groups, it is preferred that a substituent be bonded to the p-position in each aryl group.

Next, compound (ZI-2) will be explained.

Compound (ZI-2) is a compound represented by formula (ZI) wherein R₂₀₁ to R₂₀₃ each independently represents an organic group containing no aromatic ring.

The term aromatic ring herein implies any of aromatic rings including ones containing one or more heteroatoms.

The organic groups containing no aromatic ring which are represented by R₂₀₁ to R₂₀₃ each have generally 1-30, preferably 1-20 carbon atoms.

Preferably, R₂₀₁ to R₂₀₃ each independently are an alkyl, cycloalkyl, allyl, or vinyl group. R₂₀₁ to R₂₀₃ each more preferably are a linear, branched, or cyclic 2-oxoalkyl or alkoxycarbonylmethyl group, and even more preferably are a linear or branched 2-oxoalkyl group.

The alkyl groups represented by R₂₀₁ to R₂₀₃ may be either linear or branched. Preferred examples thereof include linear or branched alkyl groups having 1-10 carbon atoms (e.g., methyl, ethyl, propyl, butyl, and pentyl). The alkyl groups represented by R₂₀₁ to R₂₀₃ more preferably are linear or branched 2-oxoalkyl groups or alkoxycarbonylmethyl groups.

Preferred examples of the cycloalkyl groups represented by R₂₀₁ to R₂₀₃ include cycloalkyl groups having 3-10 carbon atoms (e.g., cyclopentyl, cyclohexyl, and norbornyl). The cycloalkyl groups represented by R₂₀₁ to R₂₀₃ more preferably are cyclic 2-oxoalkyl groups.

Preferred examples of the linear, branched, or cyclic 2-oxoalkyl groups represented by R₂₀₁ to R₂₀₃ include the alkyl and cycloalkyl groups enumerated above which each have >C═O in the 2-position.

Examples of the alkoxy groups in the alkoxycarbonylmethyl groups represented by R₂₀₁ to R₂₀₃ include alkoxy groups preferably having 1-5 carbon atoms (methoxy, ethoxy, propoxy, butoxy, and pentoxy).

R₂₀₁ to R₂₀₃ may have been further substituted by substituents selected from halogen atoms, alkoxy groups (e.g., ones having 1-5 carbon atoms), hydroxyl, cyano, and nitro.

Compound (ZI-3) is a compound represented by the following general formula (ZI-3). Namely, it is a compound having a phenacylsulfonium salt structure.

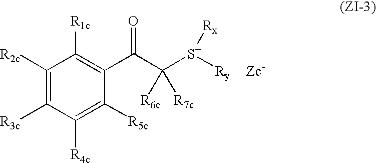

In general formula (ZI-3),

R_{1C} to R_{5C} each independently represents a hydrogen atom, alkyl, cycloalkyl, or alkoxy group, or halogen atom.

R_{6C} and R_{7C} each independently represents a hydrogen atom or an alkyl or cycloalkyl group.

Rₓ and R_{y} each independently represents an alkyl, cycloalkyl, allyl, or vinyl group.

Two or more of R_{1C} to R_{5C}, R_{6C} and R_{7C}, and Rₓ and R_{y} each may be bonded together to form a ring structure. These ring structures may contain an oxygen atom, sulfur atom, ester bond, or amide bond. Examples of the groups formed by the bonding of two or more of R_{1C} to R_{5C}, bonding of R_{6C} and R_{7C}, and bonding of Rₓ and R_{y} include butylene and pentylene.

Zc⁻ represents a non-nucleophilic anion, which is the same as the non-nucleophilic anion X⁻ in general formula (ZI).

The alkyl groups represented by R_{1C} to R_{7C} may be either linear or branched. Examples thereof include linear and branched alkyl groups having 1-20, preferably 1-12 carbon atoms (e.g., methyl, ethyl, linear or branched propyl, linear or branched butyl, and linear or branched pentyl).

Examples of the cycloalkyl groups represented by R_{1C} to R_{7C} include cycloalkyl groups preferably having 3-8 carbon atoms (e.g., cyclopentyl and cyclohexyl).

The alkoxy groups represented by R_{1C} to R_{5C} may be either linear, branched, or cyclic. Examples thereof include alkoxy groups having 1-10 carbon atoms. Preferred examples thereof include linear and branched alkoxy groups having 1-5 carbon atoms (e.g., methoxy, ethoxy, linear or branched propoxy, linear or branched butoxy, and linear or branched pentoxy) and cyclic alkoxy groups having 3-8 carbon atoms (e.g., cyclopentyloxy and cyclohexyloxy).

It is preferred that any of R_{1C} to R_{5C} be a linear or branched alkyl group, a cycloalkyl group, or a linear, branched, or cyclic alkoxy group. It is more preferred that the total number of carbon atoms in R_{1C} to R_{5C} be from 2 to 15. This compound has further improved solubility in solvents and is inhibited from generating particles during storage.

Examples of the alkyl groups represented by Rₓ and R_{y} include the same alkyl groups as those enumerated above as examples of R_{1C} to R_{7C}. The alkyl groups represented by Rₓ and R_{y} each more preferably are a linear or branched 2-oxoalkyl group or an alkoxycarbonylmethyl group.

Examples of the cycloalkyl groups represented by Rₓ and R_{y} include the same cycloalkyl groups as those enumerated above as examples of R_{1C} to R_{7C}. The cycloalkyl groups represented by Rₓ and R_{y} each more preferably are a cyclic 2-oxoalkyl group.

Examples of the linear, branched, or cyclic 2-oxoalkyl groups include those alkyl and cycloalkyl groups represented by R_{1C} to R_{7C} which each have >C═O in the 2-position.

Examples of the alkoxy groups in the alkoxycarbonylmethyl groups include the same alkoxy groups as those enumerated above as examples of R_{1C} to R_{5C}.

Rₓ and R_{y} each preferably are an alkyl group having 4 or more carbon atoms, and more preferably are an alkyl group having 6 or more, especially 8 or more carbon atoms.

In general formulae (ZII) and (ZIII),

R₂₀₄ to R₂₀₇ each independently represents an aryl group, alkyl group, or cycloalkyl group.

The aryl groups represented by R₂₀₄ to R₂₀₇ preferably are aryl groups such as phenyl or naphthyl or heteroaryl groups such as an indole residue or pyrrole residue. The aryl groups each more preferably are phenyl or an indole residue.

The alkyl groups represented by R₂₀₄ to R₂₀₇ may be either linear or branched. Preferred examples thereof include linear or branched alkyl groups having 1-10 carbon atoms (e.g., methyl, ethyl, propyl, butyl, and pentyl).

Preferred examples of the cycloalkyl groups represented by R₂₀₄ to R₂₀₇ include cycloalkyl groups having 3-10 carbon atom (e.g., cyclopentyl, cyclohexyl, and norbornyl).

Examples of substituents which may be possessed by R₂₀₄ to R₂₀₇ include alkyl groups (e.g., ones having 1-15 carbon atoms), cycloalkyl groups (e.g., ones having 3-15 carbon atoms), aryl groups (e.g., ones having 6-15 carbon atoms), alkoxy groups (e.g., ones having 1-15 carbon atoms), halogen atoms, hydroxyl, and phenylthio.

X⁻ represents a non-nucleophilic anion, and examples thereof include the same non-nucleophilic anions as those enumerated above as examples of the X⁻ in general formula (ZI).

Other preferred examples of the compound which generates an acid upon irradiation with actinic rays or a radiation include compounds represented by the following general formulae (ZIV), (ZV), and (ZVI).

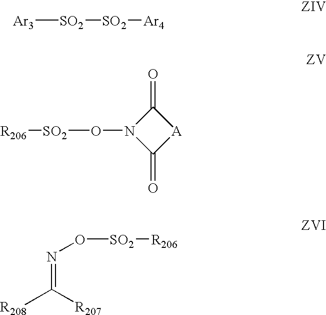

In general formulae (ZIV) to (ZVI),

Ar₃ and Ar₄ each independently represents an aryl group.

R₂₀₆ represents an alkyl group, cycloalkyl group, or aryl group.

R₂₀₇ and R₂₀₈ each independently represents an alkyl, cycloalkyl, or aryl group or an electron-attracting group. R₂₀₇ preferably is an aryl group. R₂₀₈ preferably is an electron-attracting group, and more preferably is cyano or a fluoroalkyl group.

Symbol A represents an alkylene, alkenylene, or arylene group.

More preferred of the compounds which generate an acid upon irradiation with actinic rays or a radiation are the compounds represented by general formulae (ZI) to (ZIII).

Especially preferred examples of the compounds which generate an acid upon irradiation with actinic rays or a radiation are shown below.

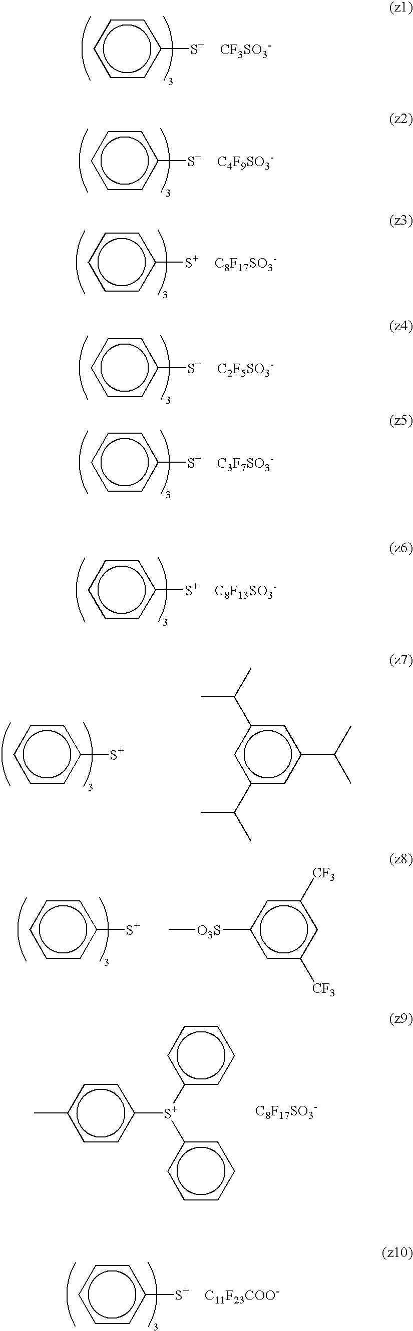

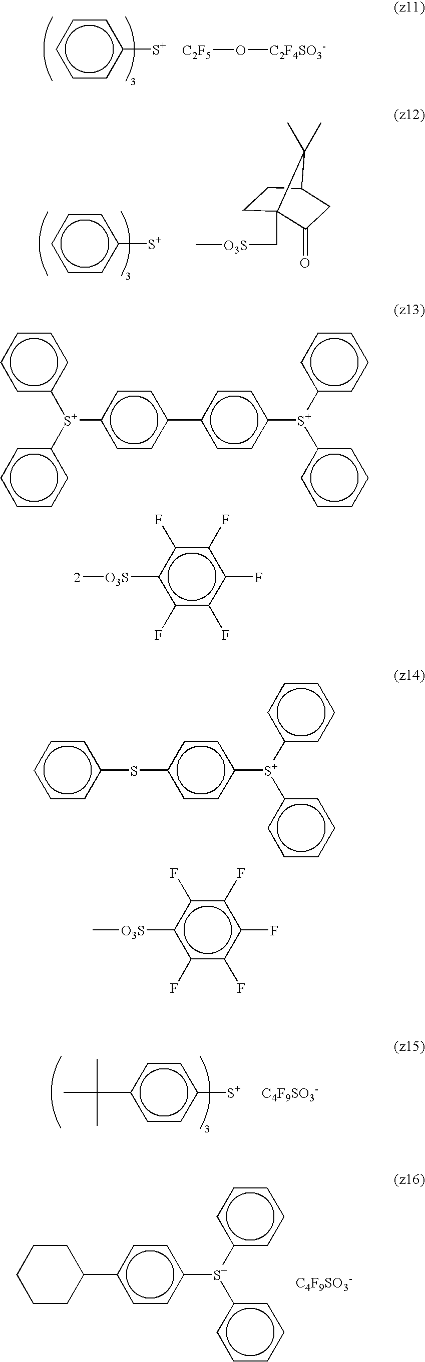

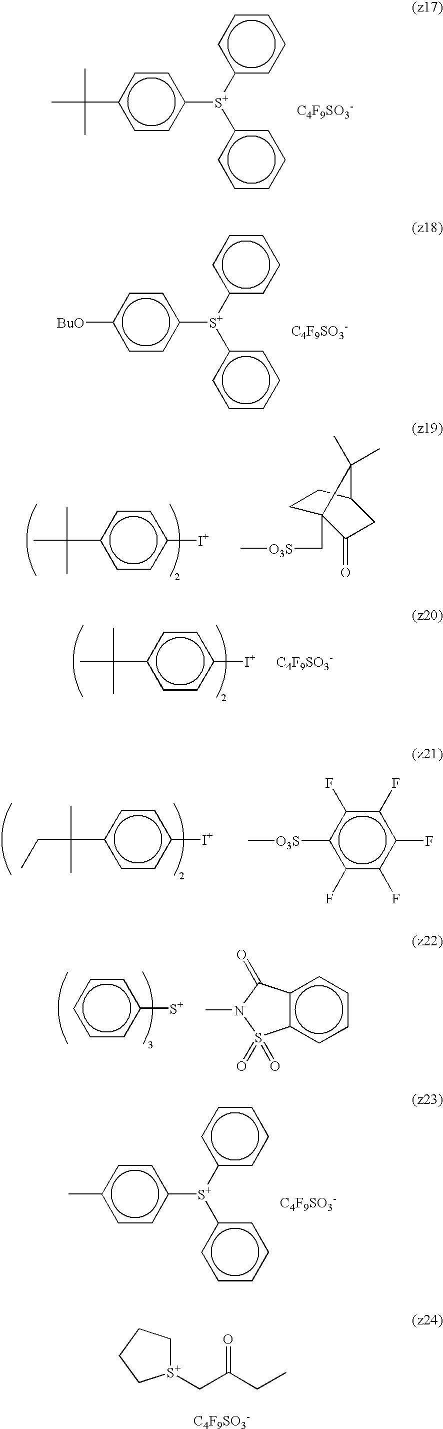

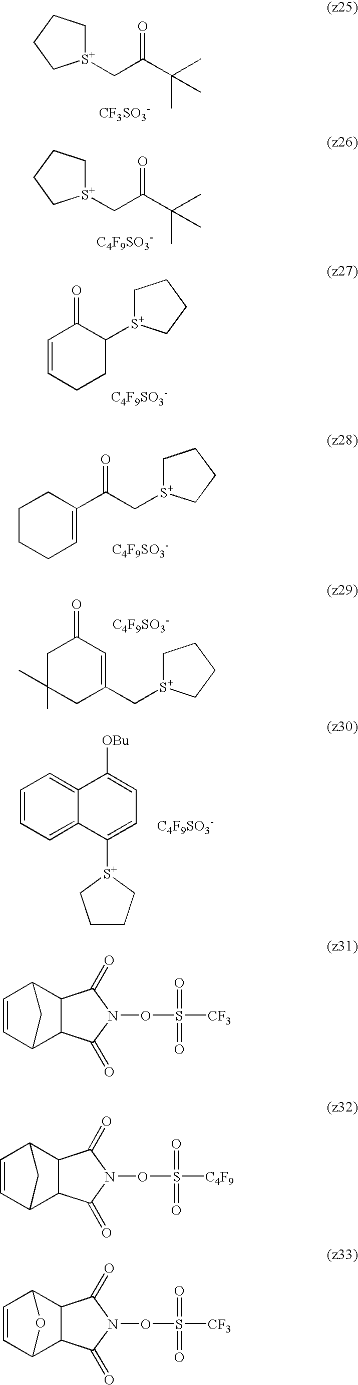

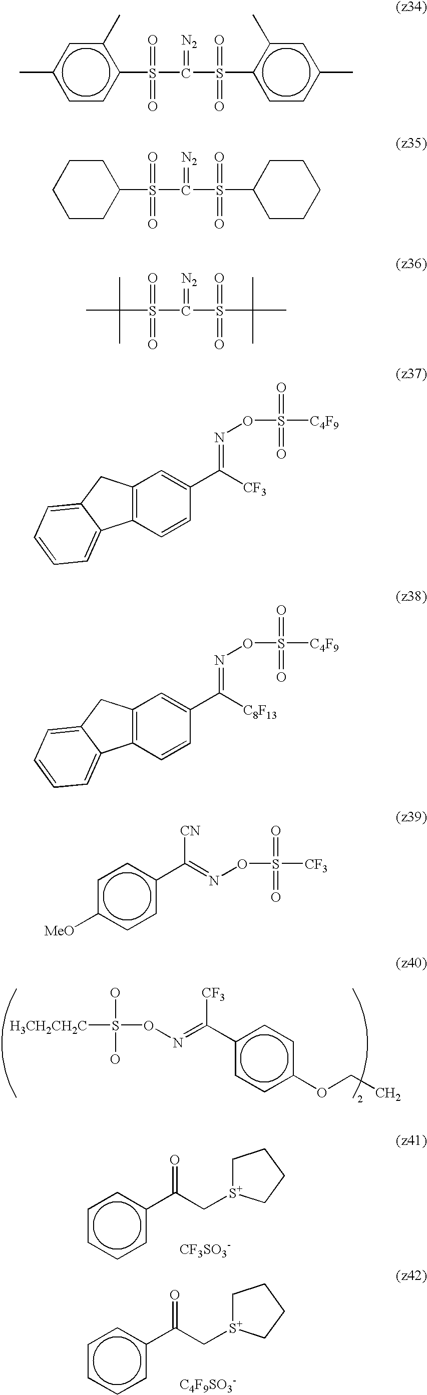

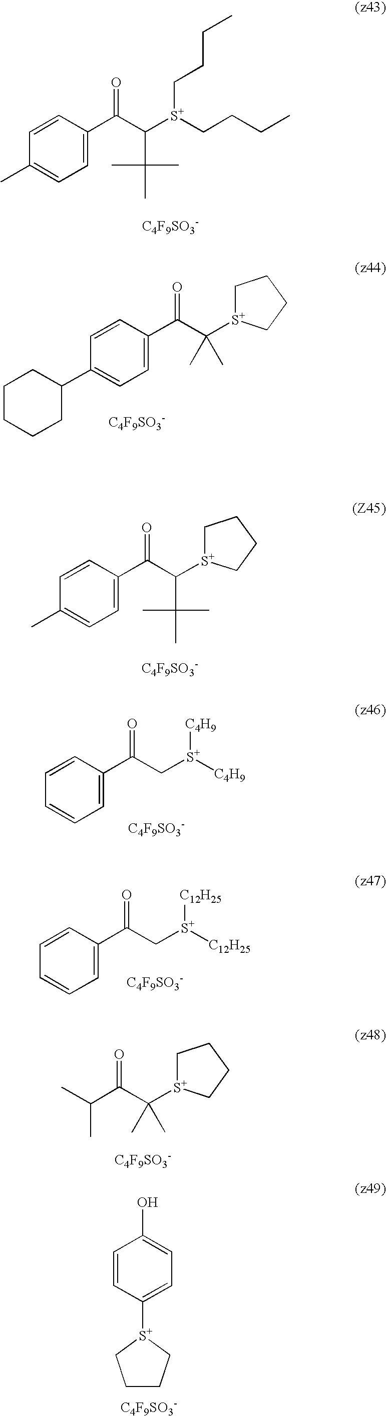

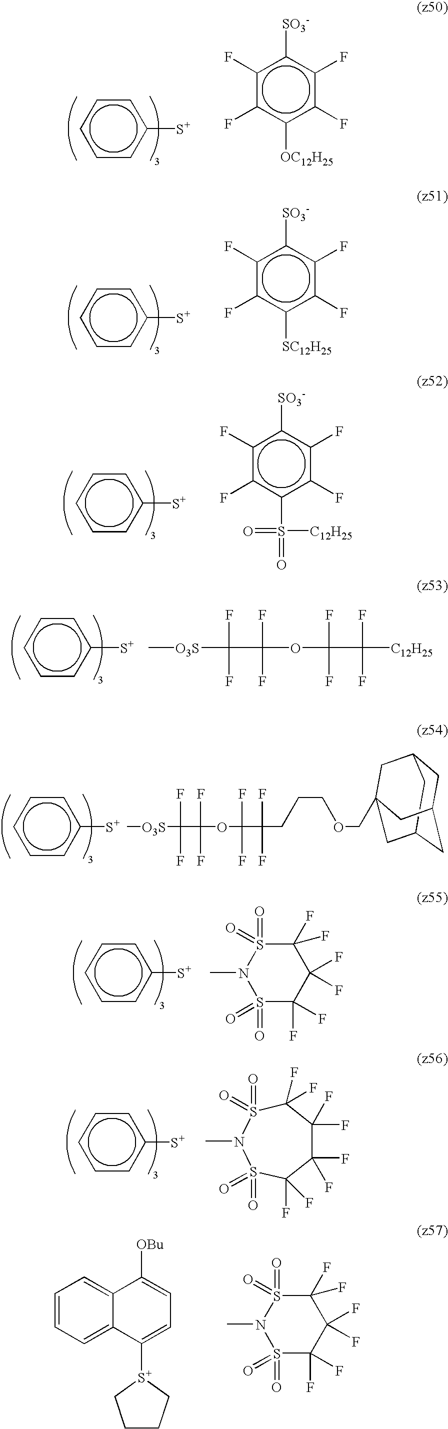

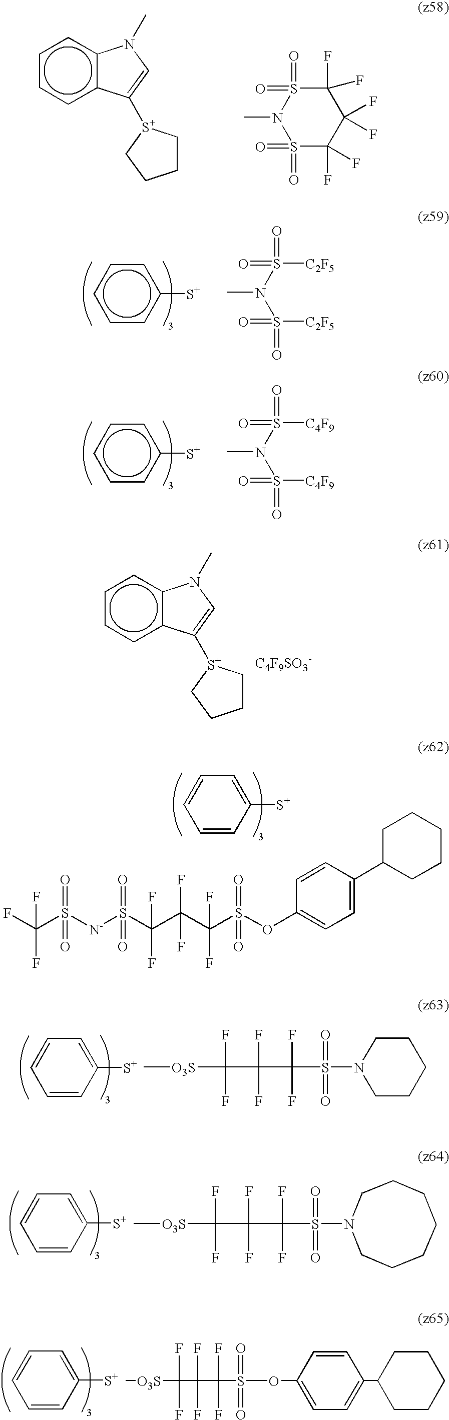

One acid generator can be used alone, or a combination of two or more acid generators can be used. In the case where two or more acid generators are used in combination, it is preferred to use a combination of compounds respectively generating two organic acids differing in the total number of atoms excluding hydrogen atoms by 2 or more.

The content of the acid generator in the positive photosensitive composition is preferably 0.1-20% by mass, more preferably 0.5-10% by mass, even more preferably 1-7% by mass, based on all solid components of the composition. (In this specification, mass ratio is equal to weight ratio.)

[2] (B) Resin Decomposing by Action of Acid to Come to Have Enhanced Solubility in Alkaline Developing Solution, Having Repeating Units (Ba) with Diamantane Structure, and Having Weight-Average Molecular Weight of 3,000 and Dispersity Ratio of 1.1-3.0

The resin decomposing by the action of an acid to come to have enhanced solubility in an alkaline developing solution, which is used in the positive photosensitive composition of the invention, is a resin which has repeating units (Ba) having a diamantane structure and has a weight-average molecular weight of 3,000 and a dispersity ratio of 1.1-3.0 (referred to also as “resin as component (B)”).

The resin as component (B) is a resin having at least one kind of groups which decompose by the action of an acid to enhance solubility in an alkaline developing solution (hereinafter referred to also as “acid-decomposable groups”). The acid-decomposable groups may be contained in the repeating units (Ba) having a diamantane structure or in other repeating units.

Examples of the acid-decomposable groups include alkali-soluble groups, such as carboxyl and hydroxyl, in which the hydrogen atom is protected with a group eliminable by the action of an acid.

Examples of the group eliminable by the action of an acid include —C(R₃₆)(R₃₇)(R₃₈), —C(R₃₆)(R₃₇)(OR₃₉), and —C(R₀₁)(R₀₂)(OR₃₉).

In the formulae, R₃₆ to R₃₉ each independently represents an alkyl group, cycloalkyl group, aryl group, aralkyl group, or alkenyl group. R₃₆ and R₃₇ may be bonded to each other to form a ring.

R₀₁ and R₀₂ each independently represents a hydrogen atom, alkyl group, cycloalkyl group, aryl group, aralkyl group, or alkenyl group.

The repeating units (Ba) having a diamantane structure preferably are repeating units selected from the following.

(Ba-1): Repeating units having an acid-decomposable group and further having a diamantane structure in the acid-eliminable group of the acid-decomposable group.

(Ba-2): Repeating units which have a diamantane structure and are influenced by neither an acid nor an alkali.

Repeating units (Ba-1) or (Ba-2) may have one or more substituents. Preferred examples of the substituents include alkyl groups and polar functional groups. Repeating units (Ba-1) or (Ba-2) preferably are repeating units having a diamantane structure substituted by one or more polar functional groups. Examples of the functional groups include hydroxyl, carboxyl, cyano, amide, sulfoneamide, and sulfonylimide groups. Preferred is hydroxyl.

(Ba-1) Repeating Units Having Acid-Decomposable Group and further Having Diamantane Structure in Acid-Eliminable Group of the Acid-Decomposable Group

The group which is eliminable by the action of an acid and has a diamantane structure preferably is a group represented by any of the following general formulae (DpI) to (DpV). The repeating units having an acid-decomposable group and further having a diamantane structure in the acid-eliminable group of the acid-decomposable group preferably are repeating units having an acid-decomposable group which is an alkali-soluble group in which the hydrogen atom is protected with a group represented by any of general formulae (DpI) to (DpV).

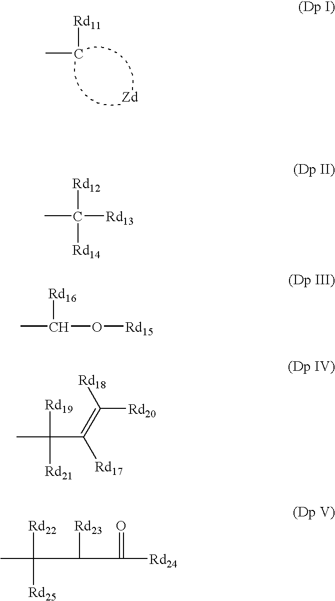

In general formulae (DpI) to (DpV),

Rd₁₁ represents methyl, ethyl, n-propyl, isopropyl, n-butyl, isobutyl, or sec-butyl, and Zd represents an atomic group necessary for forming a diamantyl group in cooperation with the carbon atom.

Rd₁₂ to Rd₁₆ each independently represents a linear or branched alkyl group having 1-4 carbon atoms or a cycloalkyl group, provided that at least one of Rd₁₂ to Rd₁₄ or either of Rd₁₅ and Rd₁₆ represents a diamantyl group or a group having a diamantyl group (preferably, an alkyl group having 1-5 carbon atoms and having a diamantyl group).

Rd₁₇ to Rd₂₁ each independently represents a hydrogen atom, a linear or branched alkyl group having 1-4 carbon atoms, or a cycloalkyl group, provided that at least one of Rd₁₇ to Rd₂₁ represents a diamantyl group or a group having a diamantyl group (preferably, an alkyl group having 1-5 carbon atoms and having a diamantyl group), and that either of Rd₁₉ and Rd₂₁ represents a linear or branched alkyl group having 1-4 carbon atoms or a cycloalkyl group.

Rd₂₂ to Rd₂₅ each independently represents a hydrogen atom, a linear or branched alkyl group having 1-4 carbon atoms, or a cycloalkyl group, provided that at least one of Rd₂₂ to Rd₂₅ represents a diamantyl group or a group having a diamantyl group (preferably, an alkyl group having 1-5 carbon atoms and having a diamantyl group), and that Rd₂₃ and Rd₂₄ may be bonded to each other to form a ring.

The repeating units having an acid-decomposable group which is an alkali-soluble group in which the hydrogen atom is protected with a group represented by any of general formulae (DpI) to (DpV) preferably are repeating units represented by the following general formula (DpA).

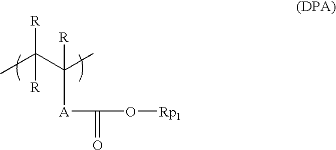

In general formula (DPA),

R represents a hydrogen atom, halogen atom, linear or branched alkyl group having 1-4 carbon atoms, carboxyl, alkoxycarbonyl group, or hydroxymethyl. The R's may be the same or different.

Symbol A represents one member or a combination of two or more members selected from the group consisting of a single bond and alkylene, ether, thioether, carbonyl, ester, amide, sulfonamide, urethane, and urea groups. Preferably, A is a single bond.

Rp₁ represents a group represented by any of general formulae (DpI) to (DpV).

Preferred examples of repeating units (Ba-1) are shown below, but the repeating units in the invention should not be construed as being limited to the following examples.
(In the formulae, Rx is H, CH₃, CF₃, or CH₂OH, and Rxa and Rxb each are an alkyl group having 1-4 carbon atoms.)

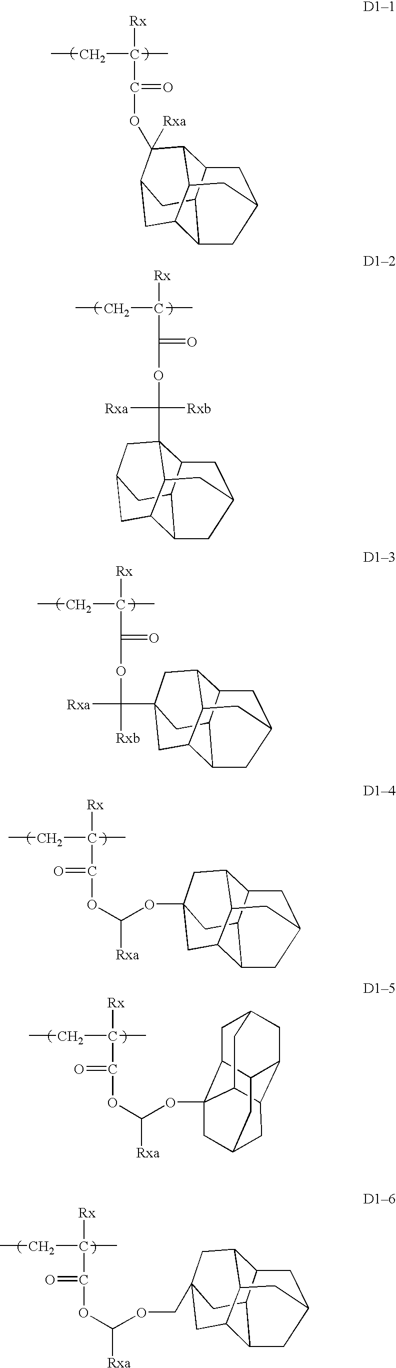

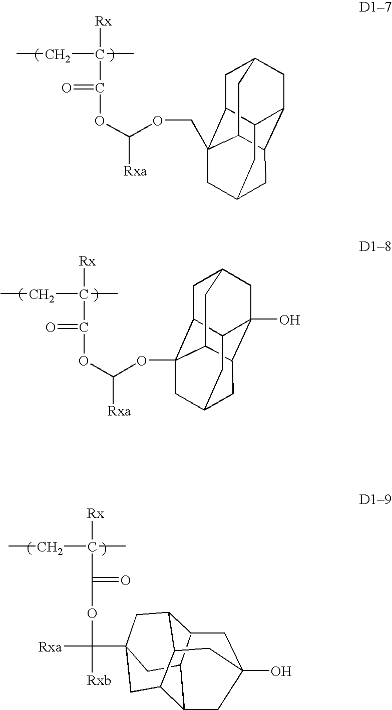

In the examples shown above,

Rx represents H, CH₃, CF₃, or CH₂OH.

Rxa and Rxb each independently represents a linear or branched alkyl group having 1-4 carbon atoms or a cycloalkyl group having 3-6 carbon atoms, provided that the alkyl or cycloalkyl chain may contain one or more heteroatoms, e.g., oxygen or sulfur atoms, therein.

(Ba-2) Repeating Units Having Diamantane Structure and Influenced by neither Acid nor Alkali

In the invention, the term “influenced by neither an acid nor an alkali” as used for repeating units means that these repeating units have no or extremely low reactivity with acids or alkalis in processes in which the positive photosensitive composition of the invention is generally used and that the repeating units have substantially no groups which contribute to image formation based on the action of an acid or alkali. In the case of a chemical amplification type positive resist, for example, a resist pattern is formed in the following manner. In an exposure step, the acid generator present in the exposed areas decomposes to generate an acid. In a post-heating step, the acid decomposes a resin having acid-decomposable groups and the resin thus releases alkali-soluble groups. As a result, the exposed areas only become alkali-developable. In an alkali development step, the exposed areas are selectively removed to thereby form a pattern. Repeating units (Ba-2) have no or extremely low reactivity with the acid and alkali generated or used in the exposure, post-heating, or development step, and have substantially no group contributing to a change in solubility contrast.

Repeating units (Ba-2) are preferably represented by the following general formula (DPB).

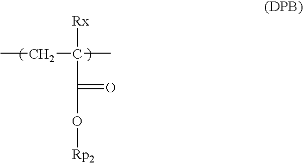

In general formula (DPB),

Rx represents H, CH₃, CF₃, or CH₂OH.

Rp₂ represents a group which is a diamantyl group or a group having a diamantyl group (preferably an alkyl group having 1-5 carbon atoms and having a diamantyl group) and does not leave from the oxygen atom by the action of an acid or alkali. Examples of the group which does not leave from the oxygen atom by the action of an acid or alkali include groups bonded through a primary or secondary ester bond. Furthermore, the tertiary ester structures shown in the following D2-1, D2-2, and D2-5 to D2-14, in which the diamantyl group is bonded at the 1-, 4-, 6-, or 9-position tertiary carbon atom through an ester bond, show no acid decomposability and make substantially no contribution to image formation based on the action of an acid. These structures also are preferred.

Preferred examples of repeating units (Ba-2) are shown below, but the repeating units in the invention should not be construed as being limited to the following examples.

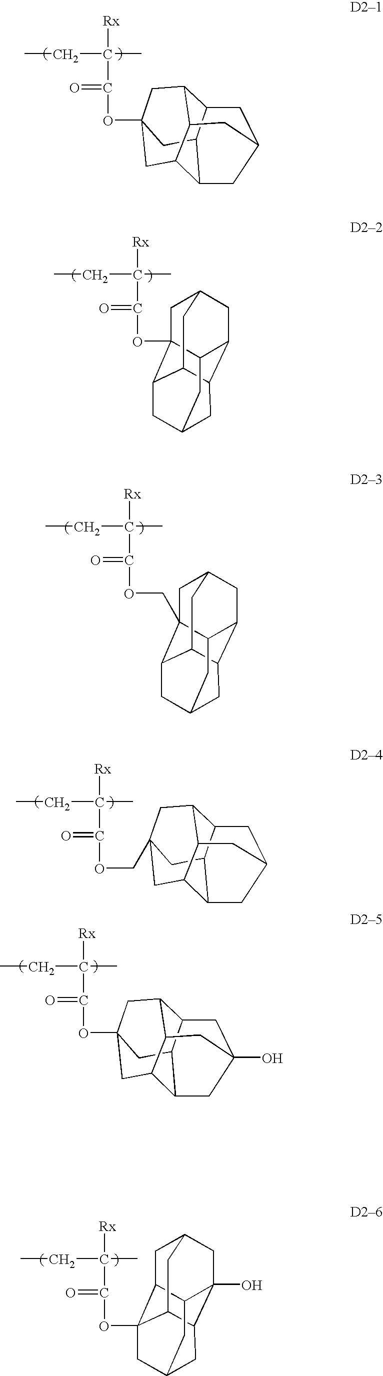

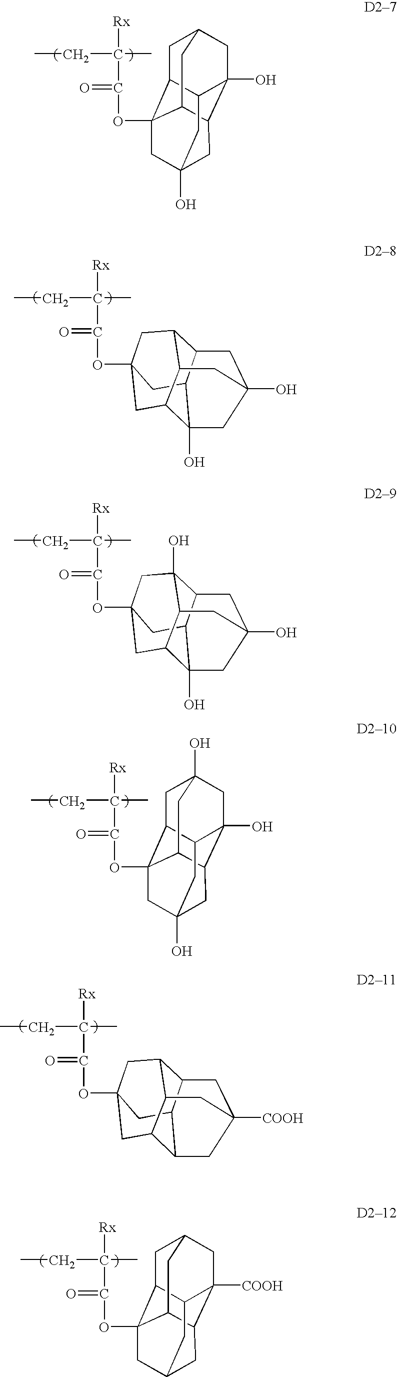

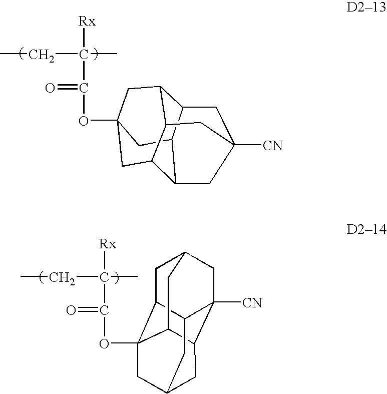

In the examples given above,

Rx represents H, CH₃, CF₃, or CH₂OH.

In the case where the repeating units (Ba) having a diamantane structure have no acid-decomposable groups, the resin as component (B) has acid-decomposable groups in other repeating units. The resin as component (B) may have: repeating units (Ba-1) having an acid-decomposable group and further having a diamantane structure in the acid-eliminable group of the acid-decomposable group; and other repeating units having an acid-decomposable group. Preferred acid-decomposable groups are groups formed by replacing the hydrogen atom of a —COOH or —OH group by an acid-eliminable group. In the invention, the acid-decomposable group preferably is an acetal group or a tertiary ester group.

In the case where acid-decomposable groups are bonded as side chains, the base resin is an alkali-soluble resin having a —OH or —COOH group in side chains. Examples thereof include the alkali-soluble resins which will be described later.

Those alkali-soluble resins have a rate of alkali dissolution of preferably 170 A/sec or higher, especially preferably 330 A/sec or higher (A represents angstrom), as measured in 0.261-N tetramethylammonium hydroxide (TMAH) (23° C.). From such standpoint, especially preferred alkali-soluble resins are alkali-soluble resins having hydroxystyrene structural units, such as poly(o-, m-, or p-hydroxystyrene) and copolymers of these hydroxystyrenes, hydrogenated poly(hydroxystyrene)s, halogen- or alkyl-substituted poly(hydroxystyrene)s, partly O-alkylated or O-acylated poly(hydroxystyrene)s, styrene/hydroxystyrene copolymers, α-methylstyrene/hydroxystyrene copolymers, and hydrogenated novolak resins, and alkali-soluble resins having repeating units having a carboxyl group, such as (meth)acrylic acid polymers and norbornenecarboxylic acid polymers.

The resin as component (B) can be obtained by reacting an alkali-soluble resin with a precursor for an acid-decomposable group or by copolymerizing an alkali-soluble-resin monomer having an acid-decomposable group with any of various monomers, as disclosed in, e.g., European Patent 254,853, JP-A-2-25850, JP-A-3-223860, and JP-A-4-251259.

The repeating units having an acid-decomposable group other than repeating units (Ba-1) preferably are at least one kind selected from repeating units having an alkali-soluble group protected by a chain tertiary alkyl group, such as t-butyl or t-pentyl, or by a group having a partial structure which includes an alicyclic hydrocarbon and is represented by any of the following general formulae (pI) to (pV).

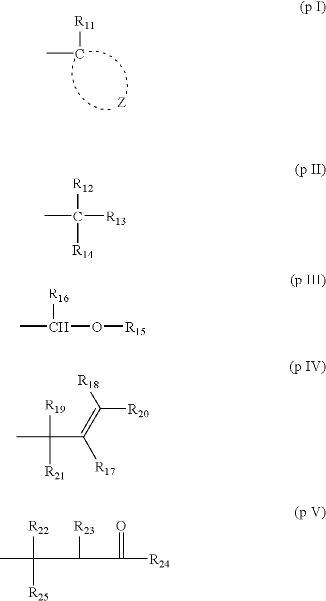

In general formulae (pI) to (pV),

R₁₁ represents methyl, ethyl, n-propyl, isopropyl, n-butyl, isobutyl, or sec-butyl, and Z represents an atomic group necessary for forming a cycloalkyl group in cooperation with the carbon atom.

R₁₂ to R₁₆ each independently represents a linear or branched alkyl group having 1-4 carbon atoms or a cycloalkyl group, provided that at least one of R₁₂ to R₁₄ or either of R₁₅ and R₁₆ represents a cycloalkyl group.

R₁₇ to R₂₁ each independently represents a hydrogen atom, a linear or branched alkyl group having 1-4 carbon atoms, or a cycloalkyl group, provided that at least one of R₁₇ to R₂₁ represents a cycloalkyl group and that either of R₁₉ and R₂₁ represents a linear or branched alkyl group having 1-4 carbon atoms or a cycloalkyl group.

R₂₂ to R₂₅ each independently represents a hydrogen atom, a linear or branched alkyl group having 1-4 carbon atoms, or a cycloalkyl group, provided that at least one of R₂₂ to R₂₅ represents a cycloalkyl group and that R₂₃ and R₂₄ may be bonded to each other to form a ring.

In general formulae (pI) to (pV), the alkyl groups represented by R₁₂ to R₂₅ are linear or branched alkyl groups having 1-4 carbon atoms. Examples thereof include methyl, ethyl, and propyl.

The cycloalkyl groups represented by R₁₂ to R₂₅ and the cycloalkyl group formed by Z and a carbon atom may be monocyclic or polycyclic. Examples thereof include groups having a monocyclic, bicyclic, tricyclic, or tetracyclic structure having 5 or more carbon atoms, preferably 6-30 carbon atoms, especially preferably 7-25 carbon atoms. These cycloalkyl groups may have substituents.

Preferred examples of the cycloalkyl groups include adamantyl, noradamantyl, decalin residues, tricyclodecanyl, tetracyclododecanyl, norbornyl, cedrol, cyclopentyl, cyclohexyl, cycloheptyl, cyclooctyl, cyclodecanyl, and cyclododecanyl.

More preferred examples thereof include adamantyl, norbornyl, cyclohexyl, cyclopentyl, tetracyclododecanyl, and tricyclodecanyl.

Those alkyl and cycloalkyl groups may have substituents. Examples of these substituents include alkyl groups (having 1-4 carbon atoms), halogen atoms, hydroxyl, alkoxy groups (having 1-4 carbon atoms), carboxyl, and alkoxycarbonyl groups (having 2-6 carbon atoms). These alkyl, alkoxy, alkoxycarbonyl groups and the like may have substituents, examples of which include hydroxyl, halogen atoms, and alkoxy groups.

The structures represented by general formulae (pI) to (pV) in the resin are used for the protection of alkali-soluble groups. Specific examples of such protected structures are ones in which the hydrogen atom of a carboxyl, sulfo, phenol, or thiol group has been replaced by a structure represented by any of general formula (pI) to (pV). Preferred are structures in which the hydrogen atom of a carboxyl or sulfo group has been replaced by a structure represented by any of general formulae (pI) to (pV).

The repeating units having an alkali-soluble group protected by a structure represented by any of general formulae (pI) to (pV) preferably are repeating units represented by the following general formula (pA).

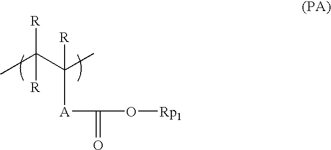

In general formula (pA), R represents a hydrogen atom, halogen atom, or linear or branched alkyl group having 1-4 carbon atoms. The R's may be the same or different.

Symbol A represents one member or a combination of two or more members selected from the group consisting of a single bond and alkylene, ether, thioether, carbonyl, ester, amide, sulfonamide, urethane, and urea groups. Preferably, A is a single bond.

Rp₁ represents a group represented by any of formulae (pI) to (pV).

The repeating units represented by general formula (pA) more preferably are repeating units derived from a 2-alkyl-2-adamantyl (meth)acrylate, 2-(1-adamantyl)-2-propyl (meth)acrylate, 1-alkyl-1-cyclopentyl (meth)acrylate, or 1-alkyl-1-cyclohexyl (meth)acrylate.

Specific examples of the repeating units represented by general formula (pA) are shown below.
(In the formulae, Rx is H, CH₃, CF₃, or CH₂OH, and Rxa and Rxb each are an alkyl group having 1-4 carbon atoms.)

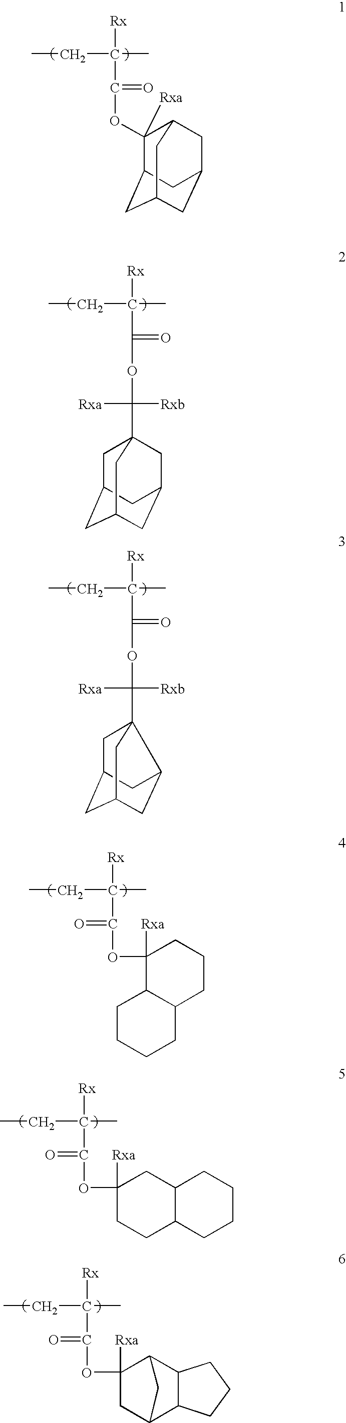

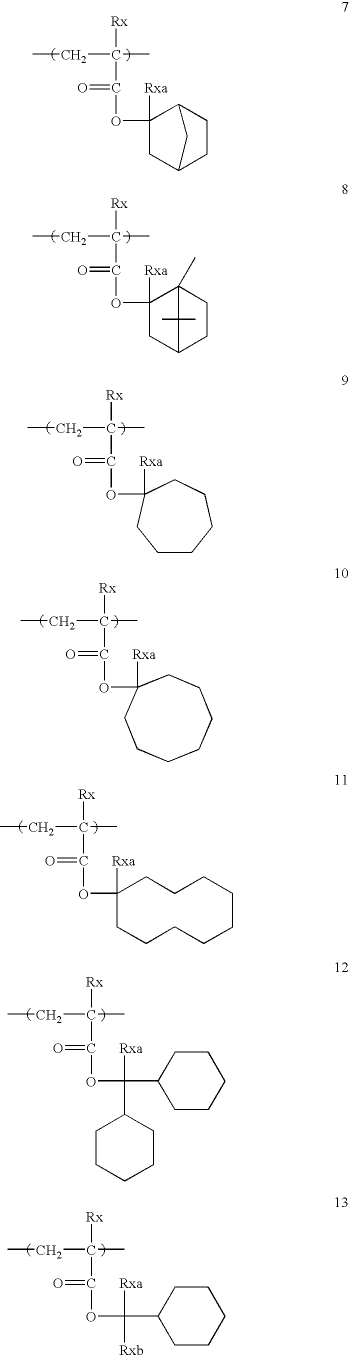

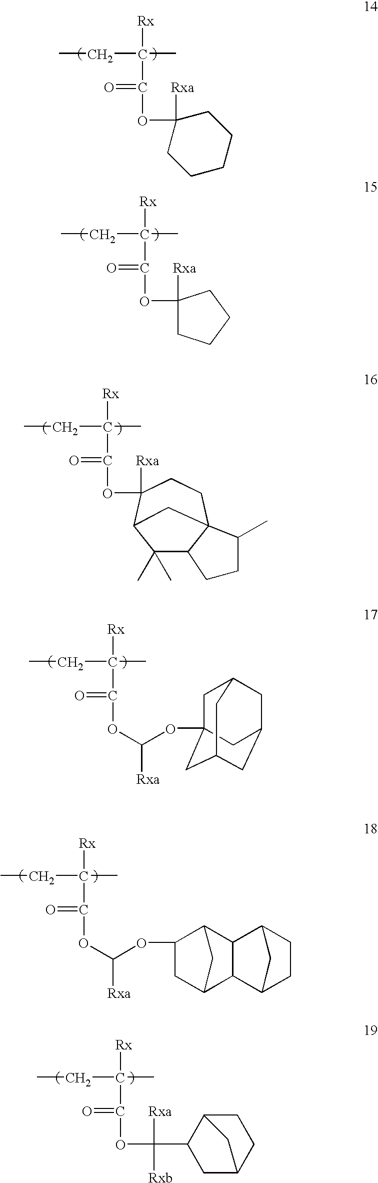

The resin as component (B) preferably further has non-acid-decomposable repeating units.

Examples of the non-acid-decomposable repeating units include the non-acid-decomposable repeating units having a lactone group which will be explained below and non-acid-decomposable repeating units having an alicyclic hydrocarbon structure substituted by one or more polar groups. The term “non-acid-decomposable” herein means that these repeating units have no or extremely low reactivity with acids in processes in which the positive photosensitive composition of the invention is generally used and that the repeating units have substantially no groups which contribute to image formation based on the action of an acid.

It is preferred that the resin as component (B) should have repeating units having a lactone group. The lactone group may be any group having a lactone structure. However, preferred examples thereof are groups having a 5- to 7-membered lactone structure and ones comprising a 5- to 7-membered lactone structure and another ring structure fused thereto so as to form a bicyclic structure or spiro structure. It is more preferred that the resin should have repeating units having a group having a lactone structure represented by any of the following general formulae (LC1-1) to (LC1-16). Groups having a lactone structure may have been directly bonded to the main chain. It is preferred that these lactone groups be directly bonded to the polymer main chain through non-acid-decomposable bonds. Namely, it is preferred that the repeating units having a lactone group be non-acid-decomposable repeating units. The non-acid-decomposable bonds preferably are primary or secondary ester bonds.

Primary or secondary ester bonds have no or exceedingly low reactivity with acids in processes in which the positive photosensitive composition of the invention is generally used.

Preferred lactone structures are (LC1-1), (LC1-4), (LC1-5), (LC1-6), (LC1-13), and (LC1-14). Use of such a specific lactone structure brings about satisfactory results concerning line edge roughness and development defects.

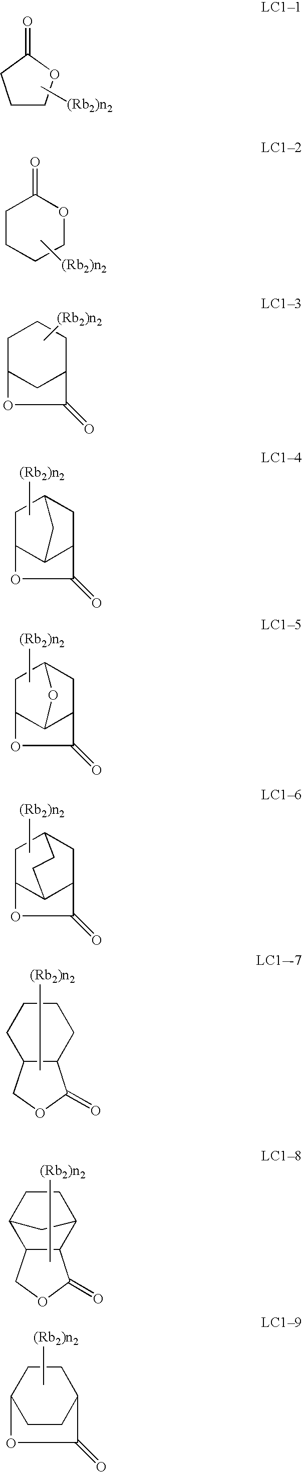

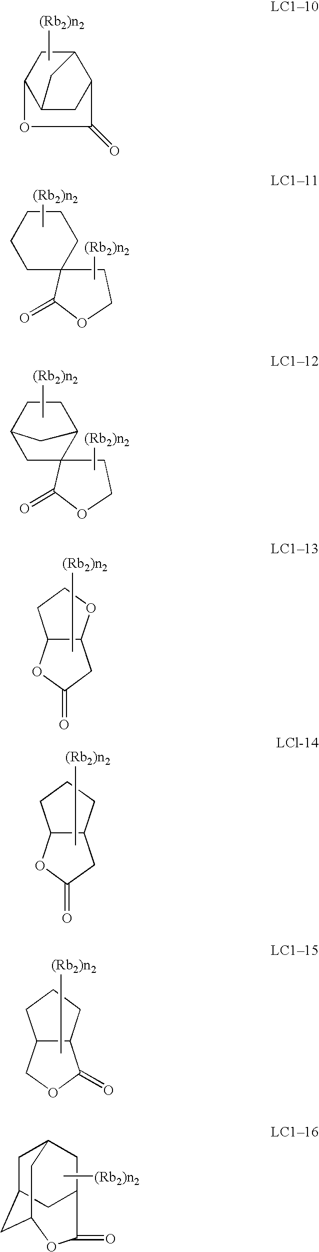

The lactone structure parts may have one or more substituents (Rb₂) or have no substituents. Preferred examples of the substituents (Rb₂) include alkyl groups having 1-8 carbon atoms, cycloalkyl groups having 4-7 carbon atoms, alkoxy groups having 1-8 carbon atoms, alkoxycarbonyl groups having 1-8 carbon atoms, carboxyl, halogen atoms, hydroxyl, cyano, and acid-decomposable groups. Symbol n₂ represents an integer of 0-4. When n₂ is 2 or larger, the Rb₂'s may be the same or different and may be bonded to each other to form a ring.

Examples of the repeating units having a group having a lactone structure represented by any of general formulae (LC1-1) to (LC1-16) include repeating units represented by the following general formula (AI).

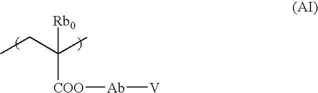

In general formula (AI),

Rb₀ represents a hydrogen atom, halogen atom, or alkyl group having 1-4 carbon atoms.

Preferred examples of substituents which may be possessed by the alkyl group represented by Rb₀ include hydroxyl and halogen atoms.

Examples of the halogen atom represented by Rb₀ include fluorine, chlorine, bromine, and iodine atoms.

Rb₀ preferably is a hydrogen atom or methyl.

Ab represents an alkylene group, a divalent connecting group having a monocyclic or polycyclic, alicyclic hydrocarbon structure, a single bond, an ether, ester, carbonyl, or carboxyl group, or a divalent group comprising a combination of two or more of these. Preferably, Ab is a single bond or a connecting group represented by -Ab₁-CO₂—. Ab₁ is a linear or branched alkylene group or a monocyclic or polycyclic cycloalkylene group, and preferably is methylene, ethylene, cyclohexylene, adamantylene, or norbornylene group.

V represents a group represented by any of general formulae (LC1-1) to (LC1-16).

Repeating units having a lactone structure generally have optical isomers, and any of these optical isomers may be used. One optical isomer may be used alone, or a mixture of two or more optical isomers may be used. In the case where one optical isomer is mainly used, it has an optical purity (ee) of preferably 90 or higher, more preferably 95 or higher.

Specific examples of the repeating units having a group having a lactone structure are shown below, but the repeating units in the invention should not be construed as being limited to the following examples.
(In the formulae, Rx is H, CH₃, CH₂OH, or CF₃.) 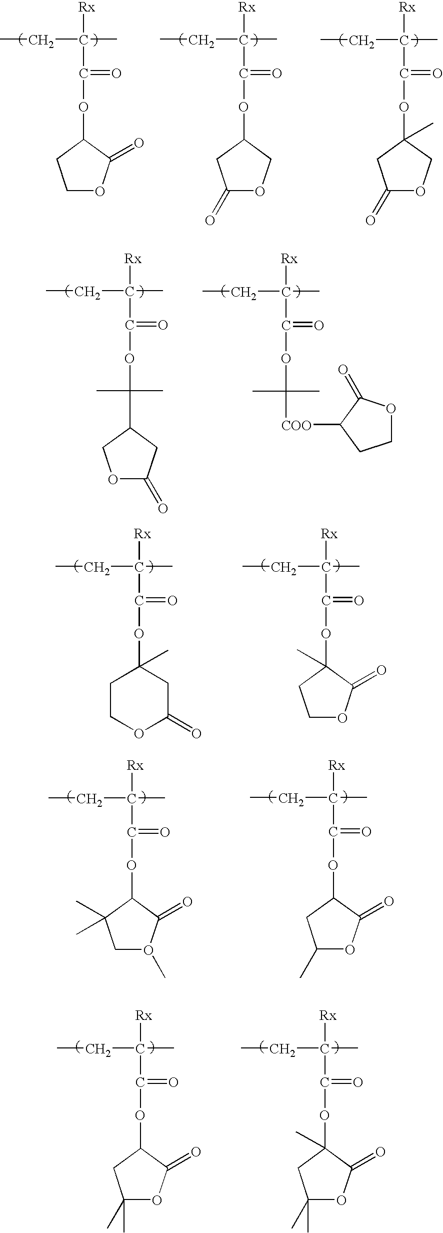 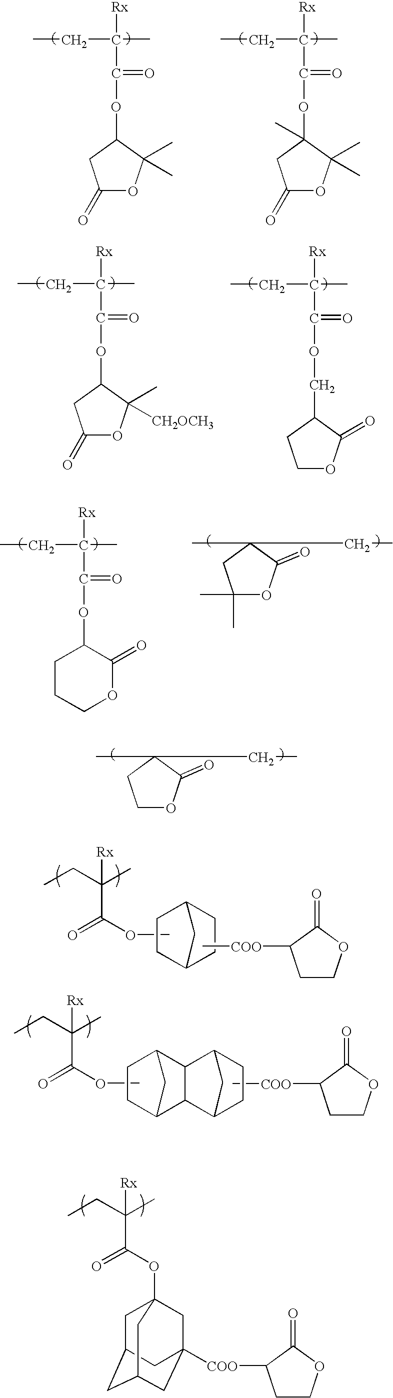
(In the formulae, Rx is H, CH₃, CH₂OH, or CF₃.) 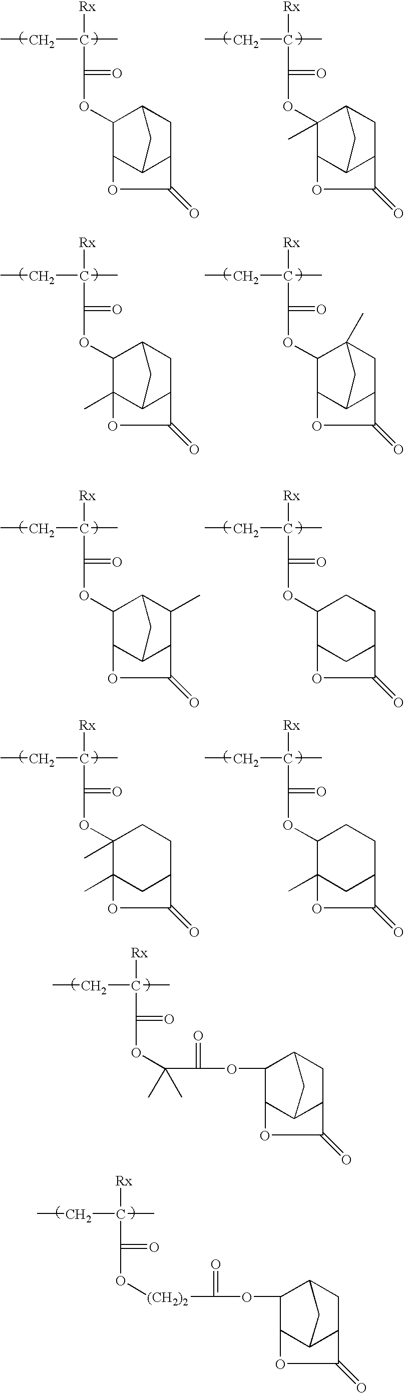 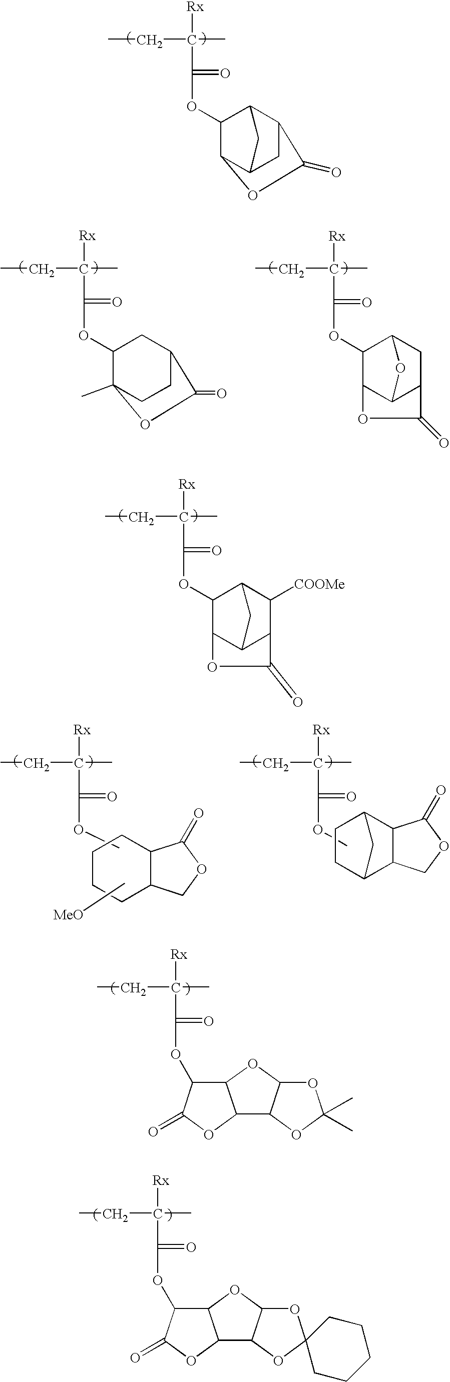 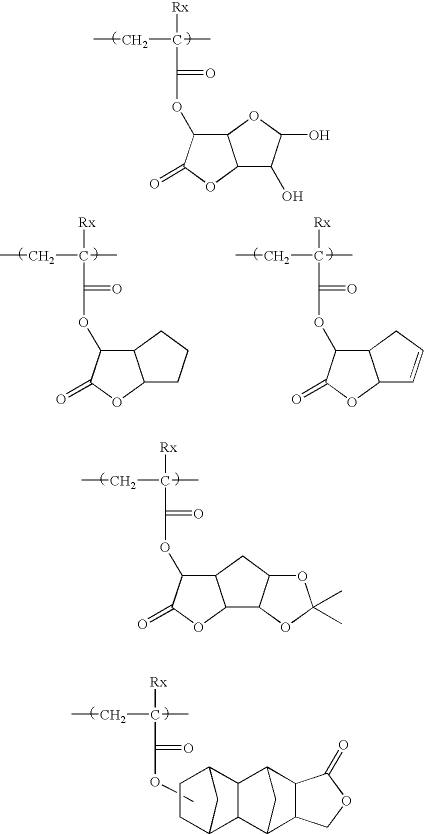
(In the formulae, Rx is H, CH₃, CH₂OH, or CF₃.)

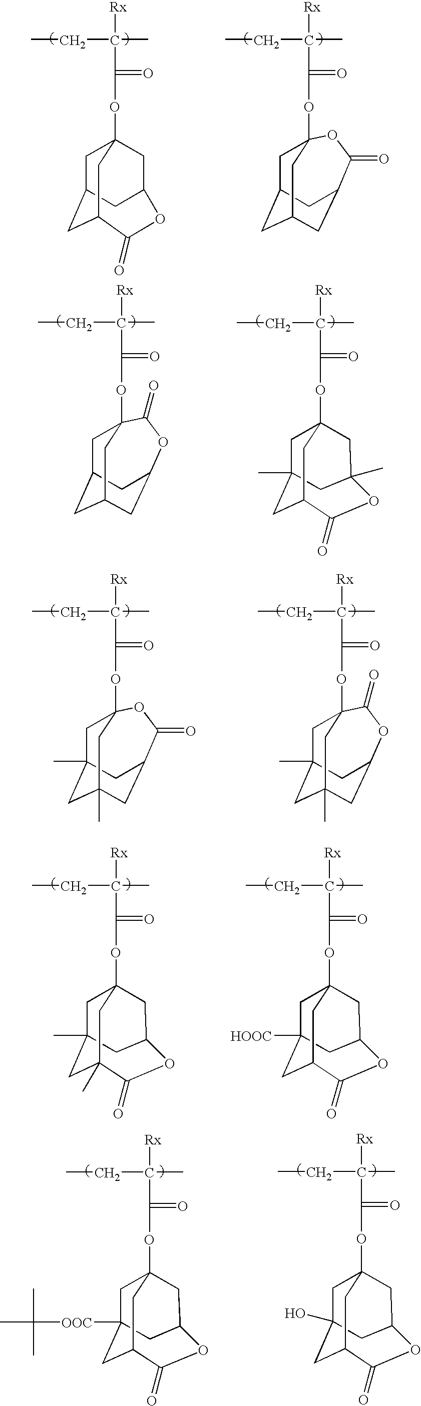

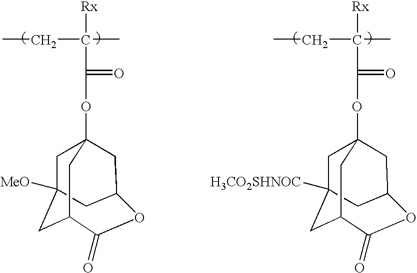

The resin as component (B) preferably has repeating units having an alicyclic hydrocarbon structure substituted by one or more polar groups. The presence of these repeating units improves adhesion to substrates and affinity for developing solutions. The polar groups preferably are hydroxyl and cyano. These repeating units preferably are repeating units having a partial structure represented by the following general formula (VIIa) or (VIIb), and more preferably are repeating units represented by the following general formula (AIIa) or (AIIb).

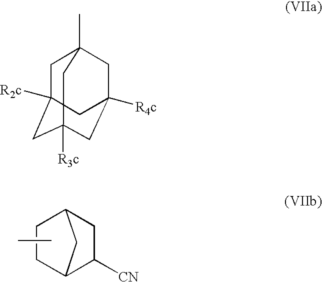

In general formula (VIIa),

R_{2c} to R_{4c} each independently represents a hydrogen atom, hydroxyl, or cyano, provided that at least one of R_{2c} to R_{4c} represents hydroxyl or cyano. Preferably, one or two of R_{2c} to R_{4c} are hydroxyl and the remaining two or one is a hydrogen atom. More preferably, two of R_{2c} to R_{4c} are hydroxyl and the remaining one is a hydrogen atom.

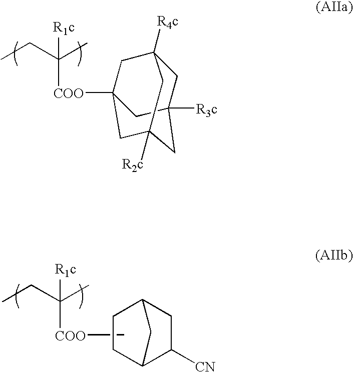

In general formulae (AIIa) and (AIIb),

R_{1c} represents a hydrogen atom, methyl, trifluoromethyl, or hydroxymethyl.

Specific examples of the repeating units having a structure represented by general formula (VIIa) or (VIIb) are shown below, but the repeating units in the invention should not be construed as being limited to the following examples.

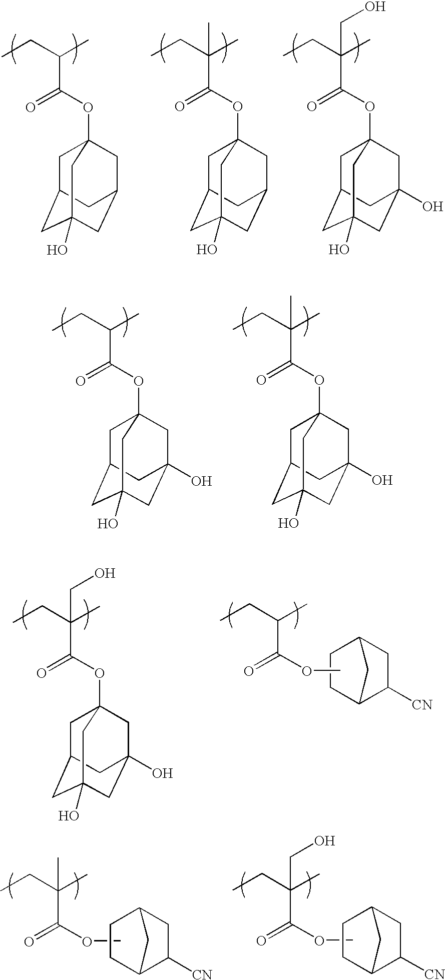

The resin as component (B) may contain repeating units represented by the following general formula (VIII).

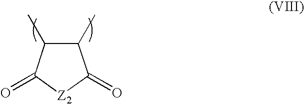

In general formula (VIII),

Z₂ represents —O— or —N(R₄₁)—. R₄₁ represents a hydrogen atom, hydroxyl, alkyl group, or —OSO₂—R₄₂. R₄₂ represents an alkyl group, cycloalkyl group, or camphor residue. The alkyl groups represented by R₄₁ and R₄₂ may be substituted by a halogen atom (preferably fluorine atom), etc.

Specific examples of the repeating units represented by general formula (VIII) include the following, but the repeating units in the invention should not be construed as being limited to these examples.

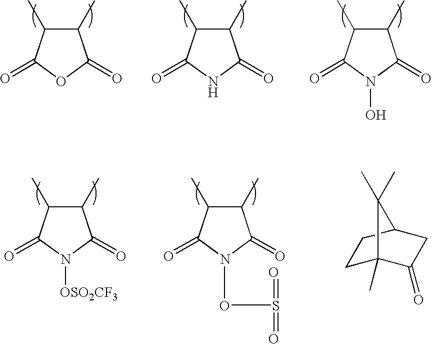

The resin as component (B) preferably has repeating units having an alkali-soluble group, and more preferably has repeating units having a carboxyl group. The presence of these repeating units enhances resolution in contact hole applications. The repeating units having a carboxyl group may be either repeating units which constitute a resin main chain having carboxyl groups directly bonded thereto, such as the repeating units derived from acrylic acid or methacrylic acid, or repeating units which constitute a resin main chain having carboxyl groups each bonded thereto through a connecting group, or ones introduced into a polymer chain end by using during polymerization a polymerization initiator or chain-transfer agent having an alkali-soluble group. Any of these types of repeating units are preferred. The connecting group may have a monocyclic or polycyclic hydrocarbon structure. Most preferred are repeating units derived from acrylic acid or methacrylic acid.

The resin as component (B) may further have repeating units having 1-3 groups represented by general formula (F1). The presence of these repeating units improves line edge roughness performance.

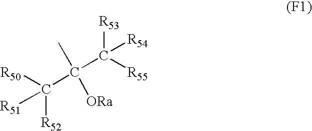

In general formula (F1),

R₅₀ to R₅₅ each independently represents a hydrogen atom, fluorine atom, or alkyl group, provided that at least one of R₅₀ to R₅₅ represents a fluorine atom or an alkyl group in which at least one hydrogen atom has been replaced by a fluorine atom.

Ra represents a hydrogen atom or an organic group (preferably, an acid-decomposable protective group or an alkyl, cycloalkyl, acyl, or alkoxycarbonyl group).

The alkyl groups represented by R₅₀ to R₅₅ may have been substituted by one or more substituents selected from halogen atoms, e.g., fluorine, cyano, etc. Preferred examples thereof include alkyl groups having 1-3 carbon atoms, such as methyl and trifluoromethyl.

It is preferred that R₅₀ to R₅₅ each be a fluorine atom.

Preferred examples of the organic group represented by Ra include acid-decomposable protective groups and alkyl, cycloalkyl, acyl, alkylcarbonyl, alkoxycarbonyl, alkoxycarbonylmethyl, alkoxymethyl, and 1-alkoxyethyl groups which may have one or more substituents.

The repeating units having 1-3 groups represented by general formula (F1) preferably are repeating units represented by the following general formula (F2).

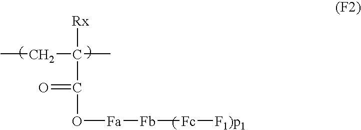

In general formula (F2),

Rx represents a hydrogen atom, halogen atom, or alkyl group having 1-4 carbon atoms. The alkyl group represented by Rx may have one or more substituents, and preferred examples of the substituents include hydroxyl and halogen atoms.

Fa represents a single bond or a linear or branched alkylene group (preferably represents a single bond).

Fb represents a monocyclic or polycyclic hydrocarbon group.

Fc represents a single bond or a linear or branched alkylene group (preferably represents a single bond or methylene group).

F₁ represents a group represented by general formula (F1).

Symbol p₁ represents 1-3.

Preferred examples of the cyclic hydrocarbon group represented by Fb include cyclopentyl, cyclohexyl, and norbornyl.

Specific examples of the repeating units having 1-3 structures represented by general formula (F1) are shown below.

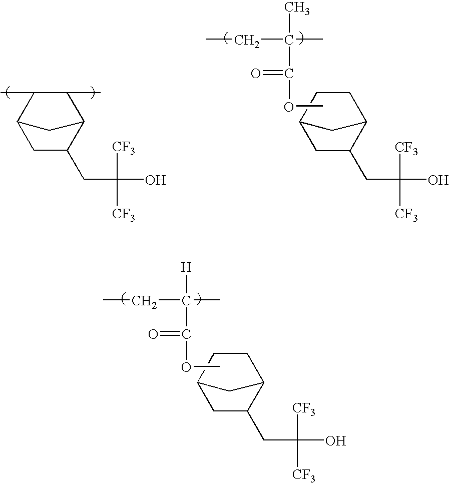

The resin a component (B) may further have repeating units which have an alicyclic hydrocarbon structure and are not acid-decomposable. The presence of these repeating units is effective in inhibiting low-molecular components contained in the resist film from dissolving in the immersion liquid during immersion exposure. Examples of such repeating units including units derived from 1-adamantyl (meth)acrylate, tricyclodecanyl (meth)acrylate, and cyclohexyl (meth)acrylate.

The resin as component (B) can contain various repeating structural units besides the repeating structural units described above for the purpose of regulating dry etching resistance, suitability for standard developing solutions, adhesion to substrates, resist profile, and general properties required of resists, such as resolution, heat resistance, sensitivity, etc.

Examples of such repeating structural units include the repeating structural units corresponding to the monomers shown below, but the optional units should not be construed as being limited to these.

Thus, performances required of the resin as component (B), in particular,

(1) solubility in solvent for application,

(2) film-forming properties (glass transition point),

(3) alkali developability,

(4) resist loss (hydrophilicity/hydrophobicity, selection of alkali-soluble group),

(5) adhesion of unexposed areas to substrate,

(6) dry etching resistance,

and the like can be delicately regulated.

Examples of such monomers include compounds having one addition-polymerizable unsaturated bond, such as acrylic esters, methacrylic esters, acrylamide and analogues thereof, methacrylamide and analogues thereof, allyl compounds, vinyl ethers, and vinyl esters.

Besides such monomers corresponding to those various repeating structural units, any addition-polymerizable unsaturated compound copolymerizable with those monomers may have been copolymerized.

In the resin as component (B), the molar proportion of each kind of repeating structural units to be contained is suitably determined in order to regulate resist properties including dry etching resistance, suitability for standard developing solutions, adhesion to substrates, and resist profile and general performances required of resists, such as resolution, heat resistance, and sensitivity.

Preferred embodiments of the resin as component (B) include one in which all repeating units have a repeating (meth)acrylate unit. This embodiment may be either a resin in which all repeating units are repeating methacrylate units, or a resin in which all repeating units are repeating acrylate units, or a resin comprising both repeating methacrylate units and repeating acrylate units. In the case where the resin comprises both repeating methacrylate units and repeating acrylate units, it is preferred that the repeating units having a polar functional group be acrylate units.

In the resin as component (B), the content of repeating units having an acid-decomposable group is preferably 10-60% by mole, more preferably 20-50% by mole, even more preferably 25-40% by mole, based on all repeating structural units.

In the resin as component (B), the content of repeating units (Ba-1) is preferably 20-50% by mole based on all repeating units.

In the resin as component (B), the content of repeating units (Ba-2) is preferably 5-30% by mole based on all repeating units.

In the case where the positive photosensitive composition of the invention is to be used for ArF exposure, the resin as component (B) preferably has no aromatic group from the standpoint of transparency to ArF light.

More preferred embodiments are: a terpolymer comprising 20-50% by mole either repeating units (Ba-1) having an acid-decomposable group and further having a diamantane structure in the acid-eliminable group of the acid-decomposable group or other repeating units having an acid-decomposable group, 20-50% by mole repeating units having a lactone structure, and 5-30% by mole either repeating units having a diamantane structure substituted by one or more polar groups or repeating units having another alicyclic hydrocarbon structure substituted by one or more polar groups; and a quadripolymer containing, besides these three kinds of repeating units, 0-20% by mole other repeating units.

Other preferred embodiments include: a terpolymer comprising 5-30% by mole repeating units (Ba-2) having a diamantane structure and undergoing substantially no influence of an acid and an alkali, 20-50% by mole acid-decomposable repeating units having an adamantane structure, and 20-50% by mole non-acid-decomposable repeating units having a lactone group; and a quadripolymer containing, besides these three kinds of repeating units, 0-20% by mole other repeating units. Examples of the acid-decomposable repeating units having an adamantane structure include repeating units represented by general formula (PA) given above wherein Rp, has an adamantane structure. Examples of the non-acid-decomposable repeating units having a lactone group include repeating units represented by general formula (AI) given above wherein V is a group which is not eliminable by the action of an acid.

It is preferred that the resin as component (B) should further have repeating units having an adamantane structure. Examples of the repeating units having an adamantane structure include repeating units represented by general formula (PA) given above wherein Rp₁ has an adamantane structure and repeating units represented by general formula (AIa) given above.

The resin as component (B) can be synthesized by ordinary methods (e.g., radical polymerization). Examples of general synthesis methods include the en bloc polymerization method in which monomers and an initiator are dissolved in a solvent and the solution is heated to thereby polymerize the monomers and the dropping polymerization method in which a solution of monomers and an initiator is added dropwise to a heated solvent over 1-10 hours. The dropping polymerization method is preferred. For adding monomers in the dropping polymerization method, use may be made of either of the following methods: a method which comprises introducing a solvent alone into a reactor and adding a monomer solution dropwise to the solvent; and a method which comprises first introducing part of the monomers into a reactor beforehand and adding the remainder dropwise thereto. Furthermore, the polymerization initiator may be added as a solution thereof which contains one or more of the monomers or as a solution separately from a monomer solution. In the case where the polymerization initiator is added as a solution separately from a monomer solution, the rate of dropping of the monomer solution and that of the initiator solution may be the same or different. Examples of the reaction solvent include ethers such as tetrahydrofuran, 1,4-dioxane, and diisopropyl ether, ketones such as methyl ethyl ketone and methyl isobutyl ketone, ester solvents such as ethyl acetate, amide solvents such as dimethylformamide and dimethylacetamide, and solvents capable of dissolving the positive photosensitive composition of the invention therein, such as those which will be shown later, e.g., propylene glycol monomethyl ether acetate, propylene glycol monomethyl ether, and cyclohexanone. It is more preferred that polymerization be conducted using the same solvent as that to be used in the positive photosensitive composition of the invention. Use of this solvent can inhibit particle generation during storage.

It is preferred that the polymerization reaction be conducted in an inert gas atmosphere such as nitrogen or argon. A commercial free-radical initiator (e.g., azo initiator or peroxide) is used as a polymerization initiator to initiate the polymerization.

The free-radical initiator preferably is an azo initiator, which preferably is an azo initiator having an ester group, cyano group, or carboxyl group. Preferred initiators include azobisisobutyronitrile, azobisdimethylvaleronitrile, and dimethyl 2,2′-azobis(2-methylpropionate). The initiator may be added additionally or in portions according to need. After completion of the reaction, the reaction mixture is poured into a solvent and the target polymer is recovered as a powder, solid, etc. The reactant concentration is 5-50% by mass, preferably 10-30% by mass. The reaction temperature is generally 10-150° C., preferably 30-120° C., more preferably 60-100° C.

The weight-average molecular weight of the resin as component (B), as determined through measurement by GPC and calculation for standard polystyrene, is 3,000, preferably 5,000, more preferably 6,000. By regulating the molecular weight thereof to a value in the proper range, improvements in exposure latitude, development defects, scum generation, line edge roughness, etc. can be attained.

The weight-average molecular weight of the resin can be regulated by suitably selecting factors in the polymerization reaction, such as the kind and amount of the polymerization initiator, chain-transfer agent, polymerization temperature, reaction solvent, reaction mixture concentration, and polymerization method (dropping polymerization, en bloc polymerization, etc.).

The dispersity ratio (Mw/Mn) of the resin as component (B) is 1.1-3.0, preferably 1.2-2.5, more preferably 1.4-2.1. The narrower the molecular-weight distribution, the better the resolution and resist shape and the smoother the resist pattern side walls to attain excellent non-roughness properties.

For regulating the dispersity ratio, the living radical polymerization method may, for example, be used. A resin having a dispersity ratio of 1.0-1.5 can be obtained by this method. Furthermore, a resin having a low dispersity ratio may be obtained from a resin obtained by polymerization having a relatively high dispersity ratio, by removing low-molecular components or high-molecular components or both from the resin based on a difference in solubility thereof in solvents by the reprecipitation method, solvent washing method, or the like.

In the positive photosensitive composition of the invention, the amount of the resin as component (B) incorporated is preferably 50-99.99% by mass, more preferably 60-99.0% by mass, based on all solid components of the composition.

The resin to be used as component (B) in the invention may be a single resin or a combination of two or more resins.

(B2) Resin Having No Group Decomposing by Action of Acid

The positive photosensitive composition of the invention may contain a resin having no groups decomposing by the action of an acid (hereinafter referred to also as “resin as component (B2)”).

The term “having no groups decomposing by the action of an acid” means that the resin has no or extremely low decomposability by the action of an acid in image-forming processes in which the positive photosensitive composition of the invention is generally used and that the resin has substantially no groups which contribute to image formation based on acid decomposition. Examples of this resin include resins having alkali-soluble groups and resins having groups which decompose by the action of an alkali to improve solubility in an alkaline developing solution.

The resin as component (B2) preferably is, for example, a resin having at least one kind of repeating units derived from a (meth)acrylic acid derivative and/or an alicyclic olefin derivative.

Preferred examples of the alkali-soluble groups in the resin as component (B2) include a carboxyl group, phenolic hydroxyl group, aliphatic hydroxyl group substituted by an electron-attracting group in the 1- or 2-position, amino group substituted by one or more electron-attracting groups (e.g., sulfonamide, sulfonimide, and bissulfonylimide groups), and methylene or methine group substituted by one or more electron-attracting groups (e.g., a methylene or methine group substituted by at least two groups selected from ketone groups and ester groups).

Preferred examples of the groups which decompose by the action of an alkali to enhance solubility in an alkaline developing solution, in the resin as component (B2), include lactone groups and acid anhydride groups. More preferred are lactone groups.

The resin as component (B2) may further have repeating units having functional groups other than those shown above. As such repeating units having other functional groups, repeating units having suitable functional groups can be selected while taking account of dry etching resistance, hydrophilicity/hydrophobicity, interaction, etc.

Examples of the repeating units having other functional groups include repeating units having a polar functional group such as a hydroxyl, cyano, carbonyl, or ester group, repeating units having a monocyclic or polycyclic hydrocarbon structure, repeating units having a fluoroalkyl group, and repeating units having two or more of these functional groups.

The weight-average molecular weight of the resin as component (B2), as determined through measurement by GPC and calculation for standard polystyrene, is preferably 3,000, more preferably 5,000, even more preferably 6,000.

Preferred examples of the resin as component (B2) are shown below, but the resin in the invention should not be construed as being limited to the following examples.

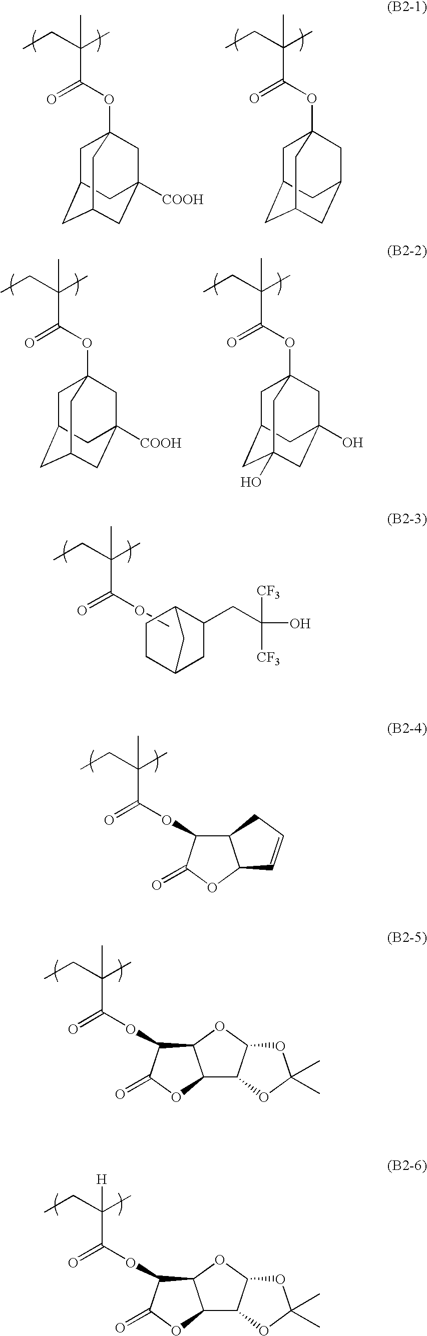

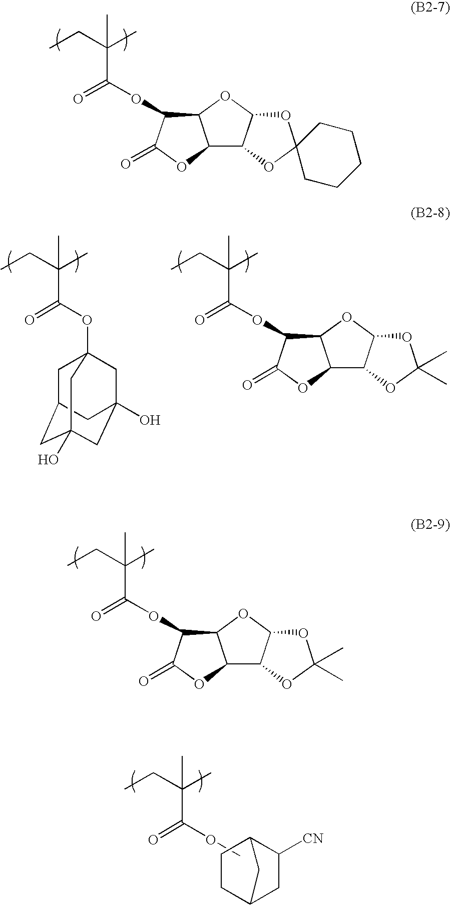

The amount of the resin as component (B2) to be added is generally 0-50% by mass, preferably 0-30% by mass, more preferably 0-20% by mass, based on the resin as component (B).

[3] (C) Dissolution Inhibitive Compound Having Molecular Weight of 3,000 or Lower and Decomposing by Action of Acid to Show Enhanced Solubility in Alkaline Developing Solution

The positive photosensitive composition of the invention may contain a dissolution inhibitive compound which has a molecular weight of 3,000 or lower and decomposes by the action of an acid to show enhanced solubility in an alkaline developing solution (hereinafter referred to also as “dissolution inhibitive compound”).

The dissolution inhibitive compound preferably is an alicycilc or aliphatic compound having an acid-decomposable group, such as the cholic acid derivatives containing an acid-decomposable group which are described in Proceeding of SPIE, 2724, 355(1996), so as not to reduce transmission at wavelengths of 220 nm and shorter. Examples of the acid-decomposable group and alicyclic structure are the same as those described above with regard to the resin as component (B).

The dissolution inhibitive compound has a molecular weight of 3,000 or lower, preferably 300-3,000, more preferably 500-2,500.

The amount of the dissolution inhibitive compound to be added is preferably 3-50% by mass, more preferably 5-40% by mass, based on all solid components of the positive photosensitive composition.

Examples of the dissolution inhibitive compound are shown below, but the compound should not be construed as being limited to the following examples.

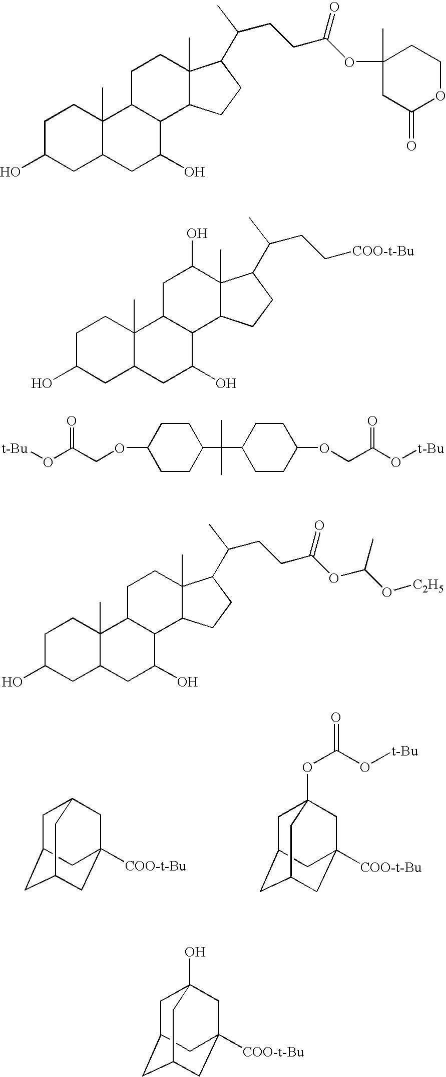

[4] (D) Basic Compound

The positive photosensitive composition of the invention preferably contains a basic compound so as to be reduced in performance changes with the lapse of time from exposure to heating or to enable the acid generated by exposure to show controlled diffusibility in the film.

Examples of the basic compound include nitrogen-containing basic compounds and onium salt compounds.

Preferred examples of the nitrogen-containing basic compounds include compounds having a partial structure represented by any of the following general formulae (A) to (E).

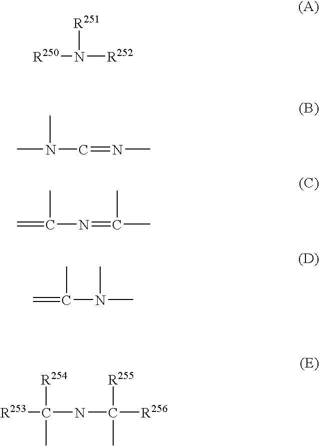

In general formula (A),

R²⁵⁰, R²⁵¹, and R²⁵² each independently are a hydrogen atom, an alkyl group having 1-20 carbon atoms, a cycloalkyl group having 3-20 carbon atoms, or an aryl group having 6-20 carbon atoms, provided that R²⁵⁰ and R²⁵¹ may be bonded to each other to form a ring. These groups may have one or more substituents. The alkyl or cycloalkyl group having one or more substituents preferably is an aminoalkyl group having 1-20 carbon atoms, aminocycloalkyl group having 3-20 carbon atoms, hydroxyalkyl group having 1-20 carbon atoms, or hydroxycycloalkyl group having 3-20 carbon atoms. These alkyl groups each may contain an oxygen, sulfur, or nitrogen atom in the alkyl chain.

In general formula (E),

R²⁵³, R²⁵⁴, R²⁵⁵, and R²⁵⁶ each independently represents an alkyl group having 1-6 carbon atoms or a cycloalkyl group having 3-6 carbon atoms.

Preferred compounds include guanidine, aminopyrrolidine, pyrazole, pyrazoline, piperazine, aminomorpholine, aminoalkylmorpholines, and piperidine, which each may having one or more substituents. More preferred compounds include compounds having an imidazole structure, diazabicyclo structure, onium hydroxide structure, onium carboxylate structure, trialkylamine structure, aniline structure, or pyridine structure, alkylamine derivatives having a hydroxy group and/or ether bond, and aniline derivatives having a hydroxy group and/or ether bond.

Examples of the compounds having an imidazole structure include imidazole, 2,4,5-triphenylimidazole, and benzimidazole. Examples of the compounds having a diazabicyclo structure include 1,4-diazabicyclo[2.2.2]octane, 1,5-diazabicyclo[4.3.0]non-5-ene, and 1,8-diazabicyclo[5.4.0]undec-7-ene. Examples of the compounds having an onium hydroxide structure include triarylsulfonium hydroxides, phenacylsulfonium hydroxide, and sulfonium hydroxides having a 2-oxoalkyl group, and specific examples thereof include triphenylsulfonium hydroxide, tris(t-butylphenyl)sulfonium hydroxide, bis(t-butylphenyl)iodonium hydroxide, phenacylthiophenium hydroxide, and 2-oxopropylthiophenium hydroxide. The compounds having an onium carboxylate structure are those compounds having an onium hydroxide structure in which the anion part has been replaced by a carboxylate, and examples thereof include acetates, adamantane-1-carboxylates, and perfluoroalkylcarboxylates. Examples of the compounds having a trialkylamine structure include tri(n-butyl)amine and tri(n-octyl)amine. Examples of the aniline compounds include 2,6-diisopropylaniline and N,N-dimethylaniline. Examples of the alkylamine derivatives having a hydroxy group and/or ether bond include ethanolamine, diethanolamine, triethanolamine, and tris(methoxyethoxyethyl)amine. Examples of the aniline derivatives having a hydroxy group and/or ether bond include N,N-bis(hydroxyethyl)aniline.

Those basic compounds may be used alone or in combination of two or more thereof. The amount of the basic compounds to be used is generally 0.001-10% by mass, preferably 0.01-5% by mass, based on the solid components of the positive photosensitive composition. From the standpoint of sufficiently obtaining the effect of the addition, the amount of the compounds is preferably 0.001% by mass or larger.

From the standpoints of sensitivity and the developability of unexposed areas, the amount of the compounds is preferably 10% by mass or smaller.

[5] (E) Surfactant

The positive photosensitive composition of the invention preferably further contains a surfactant. It is more preferred that the composition should contain any one of or two or more of fluorochemical and/or silicone surfactants (fluorochemical surfactants, silicone surfactants, and surfactants containing both fluorine atoms and silicon atoms).

When the positive photosensitive composition of the invention contains a fluorochemical and/or silicone surfactant, it can show satisfactory sensitivity and resolution when irradiated with an exposure light having a wavelength of 250 nm or shorter, especially 220 nm or shorter, and give a resist pattern having satisfactory adhesion and reduced in development defects.

Examples of the fluorochemical and/or silicone surfactants include the surfactants described in JP-A-62-36663, JP-A-61-226746, JP-A-61-226745, JP-A-62-170950, JP-A-63-34540, JP-A-7-230165, JP-A-8-62834, JP-A-9-54432, JP-A-9-5988, JP-A-2002-277862, and U.S. Pat. Nos. 5,405,720, 5,360,692, 5,529,881, 5,296,330, 5,436,098, 5,576,143, 5,294,511, and 5,824,451. It is also possible to use the following commercial surfactants as they are.

Examples of usable commercial surfactants include fluorochemical or silicone surfactants such as F-Top EF301 and FE303 (manufactured by New Akita Chemical Company), Fluorad FC430 and 431 (manufactured by Sumitomo 3M Ltd.), Megafac F171, F173, F176, F189, and R08 (manufactured by Dainippon Ink & Chemicals, Inc.), Surflon S-382 and SCI 01, 102, 103, 104, 105, and 106 (manufactured by Asahi Glass Co., Ltd.), and Troysol S-366 (manufactured by Troy Chemical Co., Ltd.). Polysiloxane polymer KP-341 (manufactured by Shin-Etsu Chemical Co., Ltd.) can also be used as a silicone surfactant.

Also usable besides the known surfactants shown above is a surfactant comprising a polymer having a fluoroaliphatic group and derived from a fluoroaliphatic compound produced by the telomerization method (also called telomer method) or oligomerization method (also called oligomer method). The fluoroaliphatic compound can be synthesized by the method described in JP-A-2002-90991.

The polymer having a fluoroaliphatic group preferably is a copolymer of a monomer having a fluoroaliphatic group with a poly(oxyalkylene) acrylate and/or a poly(oxyalkylene) methacrylate. This copolymer may be one in which the monomer units are randomly distributed or be a block copolymer. Examples of the poly(oxyalkylene) group include poly(oxyethylene), poly(oxypropylene), and poly(oxybutylene). The poly(oxyalkylene) group may be a unit having, in the same chain, alkylenes having different chain lengths, such as a poly(blocks of oxyethylene, oxypropylene, and oxyethylene) or poly(blocks of oxyethylene and oxypropylene) group. The copolymer of a monomer having a fluoroaliphatic group with a poly(oxyalkylene) acrylate (or methacrylate) is not limited to binary copolymers, and may be a copolymer of three or more monomers which is obtained by copolymerization in which two or more different monomers each having a fluoroaliphatic group, two or more different poly(oxyalkylene) acrylates (or methacrylates), etc. are simultaneously copolymerized.

Examples of commercial surfactants include Megafac F178, F-470, F-473, F-475, F-476, and F-472 (manufactured by Dainippon Ink & Chemicals, Inc.).

Examples of the polymer having a fluoroaliphatic group further include a copolymer of an acrylate (or methacrylate) having a C₆F₁₃ group with a poly(oxyalkylene) acrylate (or methacrylate), a copolymer of an acrylate (or methacrylate) having a C₆F₁₃ group with poly(oxyethylene) acrylate (or methacrylate) and poly(oxypropylene) acrylate (or methacrylate), a copolymer of an acrylate (or methacrylate) having a C₈F₁₇ group with a poly(oxyalkylene) acrylate (or methacrylate), and a copolymer of an acrylate (or methacrylate) having a C₈F₁₇ group with poly(oxyethylene) acrylate (or methacrylate) and poly(oxypropylene) acrylate (or methacrylate).

Surfactants other than the fluorochemical and/or silicone surfactants described above may be used in the invention. For example, nonionic surfactants such as, e.g., polyoxyethylene alkyl ethers, polyoxyethylene alkylaryl ethers, polyoxyethylene/polyoxypropylene block copolymers, sorbitan/fatty acid esters, and polyoxyethylene-sorbitan/fatty cid esters can be used.

The amount of the surfactant to be used is preferably 0.0001-2% by mass, more preferably 0.001-1% by mass, based on the total amount of the positive photosensitive composition (excluding the solvent).

[6] (F) Solvent

The positive photosensitive composition of the invention to be used is prepared by dissolving the components in a given solvent.

Examples of usable solvents include organic solvents such as ethylene dichloride, cyclohexanone, cyclopentanone, 2-heptanone, γ-butyrolactone, methyl ethyl ketone, ethylene glycol monomethyl ether, ethylene glycol monoethyl ether, 2-methoxyethyl acetate, ethylene glycol monoethyl ether acetate, propylene glycol monomethyl ether, propylene glycol monomethyl ether acetate, toluene, ethyl acetate, methyl lactate, ethyl lactate, methyl methoxypropionate, ethyl ethoxypropionate, methyl pyruvate, ethyl pyruvate, propyl pyruvate, N,N-dimethylformamide, dimethyl sulfoxide, N-methylpyrrolidone, and tetrahydrofuran.

In the invention, solvents may be used alone or as a mixture of two or more thereof. It is, however, preferred to use a mixed solvent comprising two or more solvents having different functional groups. When this mixed solvent is used, material solubility is enhanced. As a result, not only particle generation can be inhibited from occurring with time but also a satisfactory pattern profile is obtained. Preferred examples of the functional groups possessed by solvents include ester, lactone, hydroxyl, ketone, and carbonate groups. Preferred examples of the mixed solvent having different functional groups include the following (S1) to (S5).

(S1) A mixed solvent prepared by mixing a solvent having one or more hydroxyl groups with a solvent having no hydroxyl group.

(S2) A mixed solvent prepared by mixing a solvent having an ester structure with a solvent having a ketone structure.

(S3) A mixed solvent prepared by mixing a solvent having an ester structure with a solvent having a lactone structure.

(S4) A mixed solvent prepared by mixing a solvent having an ester structure with a solvent having a lactone structure and a solvent having one or more hydroxyl groups.

(S5) A mixed solvent prepared by mixing a solvent having an ester structure with a solvent having a carbonate structure and a solvent having one or more hydroxyl groups.

Use of those mixed solvents are effective in diminishing particle generation during resist fluid storage and inhibiting resist fluid application from causing defects. Examples of the solvent having one or more hydroxyl groups include ethylene glycol, ethylene glycol monomethyl ether, ethylene glycol monoethyl ether, propylene glycol, propylene glycol monomethyl ether, propylene glycol monoethyl ether, and ethyl lactate. Preferred of these are propylene glycol monomethyl ether and ethyl lactate.

Examples of the solvent having no hydroxyl group include propylene glycol monomethyl ether acetate, ethyl ethoxypropionate, 2-heptanone, γ-butyrolactone, cyclohexanone, butyl acetate, N-methylpyrrolidone, N,N-dimethylacetamide, and dimethyl sulfoxide. Especially preferred of these are propylene glycol monomethyl ether acetate, ethyl ethoxypropionate, 2-heptanone, γ-butyrolactone, cyclohexanone, and butyl acetate. More preferred are propylene glycol monomethyl ether acetate, ethyl ethoxypropionate, 2-heptanone, and cyclohexanone.

Examples of the solvent having a ketone structure include cyclohexanone and 2-heptanone. Preferred is cyclohexanone.

Examples of the solvent having an ester structure include propylene glycol monomethyl ether acetate, ethyl ethoxypropionate, and butyl acetate. Preferred is propylene glycol monomethyl ether acetate.

Examples of the solvent having a lactone structure include γ-butyrolactone.

Examples of the solvent having a carbonate structure include propylene carbonate and ethylene carbonate. Preferred is propylene carbonate.

The ratio of the amount (by mass) of the solvent having one or more hydroxyl groups to that of the solvent having no hydroxyl group to be mixed therewith may be from 1/99 to 99/1, and is preferably from 10/90 to 90/10, more preferably from 20/80 to 60/40. The mixed solvent in which the content of the solvent having no hydroxyl group is 50% by mass or higher is especially preferred from the standpoint of evenness of application.

The ratio of the amount (by mass) of the solvent having an ester structure to that of the solvent having a ketone structure to be mixed therewith may be from 1/99 to 99/1, and is preferably from 10/90 to 90/10, more preferably from 40/60 to 80/20. The mixed solvent in which the content of the solvent having an ester structure is 50% by mass or higher is especially preferred from the standpoint of evenness of application.

The ratio of the amount (by mass) of the solvent having an ester structure to that of the solvent having a lactone structure to be mixed therewith may be from 70/30 to 99/1, and is preferably from 80/20 to 99/1, more preferably from 90/10 to 99/1. The mixed solvent in which the content of the solvent having an ester structure is 70% by mass or higher is especially preferred from the standpoint of long-term stability.

In the case where a solvent having an ester structure, a solvent having a lactone structure, and a solvent having one or more hydroxyl groups are mixed together, it is preferred that the contents of the solvent having an ester structure, the solvent having a lactone structure, and the solvent having one or more hydroxyl groups in the resultant mixed solvent be 30-80% by weight, 1-20% by weight, and 10-60% by weight, respectively.

In the case where a solvent having an ester structure, a solvent having a carbonate structure, and a solvent having one or more hydroxyl groups are mixed together, it is preferred that the contents of the solvent having an ester structure, the solvent having a carbonate structure, and the solvent having one or more hydroxyl groups in the resultant mixed solvent be 30-80% by weight, 1-20% by weight, and 10-60% by weight, respectively.

A more preferred embodiment of the solvent is a solvent comprising an alkylene glycol monoalkyl ether carboxylate (preferably propylene glycol monomethyl ether acetate). This solvent more preferably is a mixed solvent composed of an alkylene glycol monoalkyl ether carboxylate and at least one other solvent selected from solvents having a functional group selected from hydroxyl, ketone, lactone, ester, ether, and carbonate groups or having two or more of these functional groups. An especially preferred mixed solvent is composed of propylene glycol monomethyl ether acetate and at least one member selected from ethyl lactate, γ-butyrolactone, propylene glycol monomethyl ether, butyl acetate, and cyclohexanone. By selecting this especially preferred mixed solvent, development defect performance can be improved.

The ratio of the amount (by mass) of the alkylene glycol monoalkyl ether carboxylate to that of the other solvents to be mixed therewith may be from 95/5 to 30/70, and is preferably from 95/5 to 40/60, more preferably from 80/20 to 50/50. By increasing the proportion of the alkylene glycol monoalkyl ether carboxylate, performance changes with the lapse of time from application to exposure can be reduced.

The solid concentration of the positive photosensitive composition of the invention is preferably 3-15% by mass, more preferably 4-10% by mass, even more preferably 5-8% by mass.

<Other Additives>

A dye, plasticizer, photosensitizer, compound enhancing solubility in developing solutions, and other additives may be further incorporated into the positive photosensitive composition of the invention according to need.

The compound enhancing solubility in developing solutions which is usable in the invention may be a low-molecular compound having a molecular weight of 1,000 or lower and having two or more phenolic OH groups or one or more carboxyl groups.

When this compound has one or more carboxyl groups, it preferably is an alicyclic or aliphatic compound.

The amount of the solubility-enhancing compound to be added is preferably 2-50% by mass, more preferably 5-30% by mass, based on the resin as component (B).

From the standpoints of diminishing development residues and preventing pattern deformation in development, the amount thereof is preferably 50% by mass or smaller. The phenolic compound having a molecular weight of 1,000 or lower can be easily synthesized by persons skilled in the art while referring to methods described in, e.g., JP-A-4-122938, JP-A-2-28531, U.S. Pat. No. 4,916,210, and European Patent 219,294.

Examples of the alicyclic or aliphatic compound having one or more carboxyl groups include carboxylic acid derivatives having a steroid structure, such as cholic acid, deoxycholic acid, and lithocholic acid, adamantanecarboxylic acid derivatives, adamantanedicarboxylic acid, cyclohexanecarboxylic acid, and cyclohexanedicarboxylic acid. However, the alicyclic or aliphatic compound should not be construed as being limited to these.

(Method of Pattern Formation)

When the positive photosensitive composition of the invention is used, the components described above are dissolved in a given solvent, preferably the mixed solvent, and the resultant solution is filtered and then applied to a given substrate in the following manner. The filter to be used for the filtration preferably is one which is made of polytetrafluoroethylene, polyethylene, or nylon and has a pore size of 0.1 μm or smaller, more preferably 0.05 μm or smaller, even more preferably 0.03 μm or smaller.

For example, the positive photosensitive composition is applied to a base such as one for use in producing precision integrated-circuit elements (e.g., a silicon base coated with silicon dioxide) by an appropriate coating technique using a spinner, coater, or the like. The coating film is dried to form a photosensitive film.

The thickness of the photosensitive film to be formed is preferably 50-300 nm, more preferably 70-200 nm, even more preferably 80-150 nm. The effects of the positive photosensitive composition of the invention are remarkably produced when it is applied so as to give a photosensitive film having a smaller thickness.

This photosensitive film is irradiated with actinic rays or a radiation through a given mask and then preferably baked (heated). This film is developed and rinsed. Thus, a satisfactory pattern can be obtained.

When the photosensitive film is irradiated with actinic rays or a radiation, this exposure may be conducted while filling the space between the photosensitive film and a lens with a liquid (immersion medium) having a higher refractive index than air (immersion exposure). This exposure technique can heighten resolution. The immersion medium to be used can be any liquid having a higher refractive index than air. However, pure water is preferred. An overcoat layer may be further formed on the photosensitive film in order to prevent the photosensitive film from coming into direct contact with the immersion medium in immersion exposure. This overcoat layer inhibits composition extraction from the photosensitive film to the immersion medium to thereby diminish development defects.

Examples of the actinic rays or radiation include infrared, visible light, ultraviolet, far ultraviolet, X rays, and electron beams. Preferred are far ultraviolet rays having a wavelength of preferably 250 nm or shorter, more preferably 220 nm or shorter, such as, e.g., KrF excimer laser light (248 nm), ArF excimer laser light (193 nm), and F₂ excimer laser light (157 nm), X rays, electron beams, and the like. More preferred are ArF excimer laser light, F₂ excimer laser light, EUV (13 nm), and electron beams.

In a development step, an alkaline developing solution is used in the following manner. As an alkaline developing solution for the resist composition can be used an alkaline aqueous solution of, e.g., an inorganic alkali such as sodium hydroxide, potassium hydroxide, sodium carbonate, sodium silicate, sodium metasilicate, or ammonia water, a primary amine such as ethylamine or n-propylamine, a secondary amine such as diethylamine or di-n-butylamine, a tertiary amine such as triethylamine or methyldiethylamine, an alcoholamine such as dimethylethanolamine or triethanolamine, a quaternary ammonium salt such as tetramethylammonium hydroxide or tetraethylammonium hydroxide, or a cyclic amine such as pyrrole or piperidine.

It is also possible to add an alcohol or a surfactant in an appropriate amount to the alkaline developing solution to be used.

The alkali concentration of the alkaline developing solution is generally 0.1-20% by mass.

The pH of the alkaline developing solution is generally 10.0-15.0.

### EXAMPLES

The invention will be explained below by reference to Examples, but the invention should not be construed as being limited to the following Examples.

### Synthesis Example 1

### Synthesis of Monomer (A)

In 150 mL of toluene were dissolved 9.8 g of hydroxydiamantane, 3.7 g of methacrylic anhydride, and 0.5 g of concentrated sulfuric acid. This mixture was reacted for 2 hours under refluxing conditions. The resultant liquid reaction mixture was washed with an aqueous sodium hydrogen carbonate solution and subsequently with distilled water, dried with anhydrous sodium sulfate, and then concentrated to thereby obtain a crude reaction product. This product was purified by column chromatography. As a result, monomer (A) was obtained in an amount of 6.3 g.

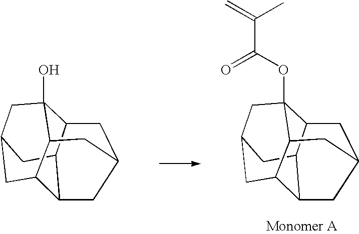

### Synthesis Example 2

### Synthesis of Monomer (B)

To 160 mL of bromine cooled at −7° C. was gradually added 40 g of diamantane while keeping the temperature of the resultant liquid reaction mixture at 10-3° C. or lower. Thereafter, 2.16 g of aluminum bromide was gradually added to the reaction mixture while keeping the temperature of the mixture at 0° C. or lower. The resultant liquid reaction mixture was stirred at −7° C. for 30 minutes and then slowly poured into a solution composed of 500 g of sodium sulfite, 160 g of sodium hydroxide, and 3 L of water. The resultant precipitate was taken out by filtration and washed with acetonitrile. Thus, 63 g of dibromodiamantane was obtained.

To 20 g of the dibromodiamantane was slowly added 80 mL of concentrated nitric acid. This mixture was heated to 70° C. and reacted for 30 minutes. The resultant liquid reaction mixture was poured into 300 mL of water. Thereto was added 72-g sodium hydroxide/500-mL water to make the mixture alkaline. The resultant precipitate was taken out by filtration and washed with water. As a result, dihydroxydiamantane was obtained in an amount of 7 g.

The dihydroxydiamantane was used to synthesize monomer (B) in the same manner as in the synthesis of monomer (A). As a result, monomer (B) was obtained in an amount of 3 g.

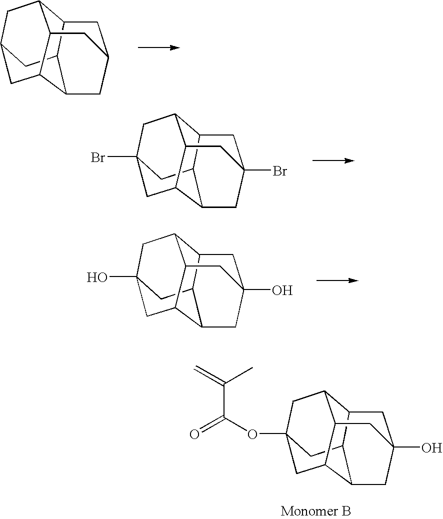

### Synthesis Example 3

### Synthesis of Resin (RA-1) (Dropping Polymerization)

In a nitrogen stream, 5.1 g of propylene glycol monomethyl ether acetate and 3.4 g of propylene glycol monomethyl ether were introduced into a three-necked flask. The contents were heated to 80° C. Thereto was added dropwise over 6 hours a solution prepared by dissolving 2.7 g of monomer (A), 4.7 g of 3-hydroxyadamantane methacrylate, 7.0 g of 2-methyl-2-adamantyl methacrylate, 6.8 g of γ-butyrolactone methacrylate, and 4 mol % initiator V-601 (manufactured by Wako Pure Chemical) based on the monomers in 46 g of propylene glycol monomethyl ether acetate and 30.7 g of propylene glycol monomethyl ether. After completion of the dropwise addition, the reaction mixture was further reacted at 80° C. for 2 hours. The resultant liquid reaction mixture was allowed to cool and then poured into 720-mL hexane/80-mL ethyl acetate. The powder precipitated was taken out by filtration and dried. As a result, resin (RA-1) was obtained in an amount of 18 g. The resin obtained had a weight-average molecular weight, as determined through measurement by GPC and calculation for standard polystyrene, of 10,700 and a dispersity ratio (Mw/Mn) of 1.81.

Resins (RA-2) to (RA-18) were synthesized in the same manner.

### Synthesis Example 4

### Synthesis of Comparative Resin (RA-1′) (Dropping Polymerization)

The same procedure as in Synthesis Example 3 was conducted, except that the amount of initiator V-601 (manufactured by Wako Pure Chemical) was changed to 1 mol % based on the monomers. Thus, resin (RA-1′) was obtained, which had the same structure as resin (RA-1). The resin (RA-1′) obtained had a weight-average molecular weight, as determined through measurement by GPC and calculation for standard polystyrene, of 33,600 and a dispersity ratio (Mw/Mn) of 2.6.

### Synthesis Example 5

### Synthesis of Comparative Resin (RA-1″) (En Bloc Polymerization)

In 51 g of propylene glycol monomethyl ether acetate and 34 g of propylene glycol monomethyl ether were dissolved 2.7 g of monomer (A), 4.7 g of 3-hydroxyadamantane methacrylate, 7.0 g of 2-methyl-2-adamantyl methacrylate, and 6.8 g of γ-butyrolactone methacrylate in a nitrogen stream. This solution was heated to 80° C. Thereto was added initiator V-601 (manufactured by Wako Pure Chemical) in an amount of 3 mol % based on the monomers. This mixture was reacted at 80° C. for 5 hours. The resultant liquid reaction mixture was allowed to cool and then poured into 720-mL hexane/80-mL ethyl acetate. The powder precipitated was taken out by filtration and dried. As a result, resin (RA-1″), which had the same structure as resin (RA-1), was obtained in an amount of 17 g. The resin (RA-1″) obtained had a weight-average molecular weight, as determined through measurement by GPC and calculation for standard polystyrene, of 35,200 and a dispersity ratio (Mw/Mn) of 3.6.

The structure, composition, weight-average molecular weight, and dispersity ratio of each of resins (RA-1) to (RA-18) are shown below.

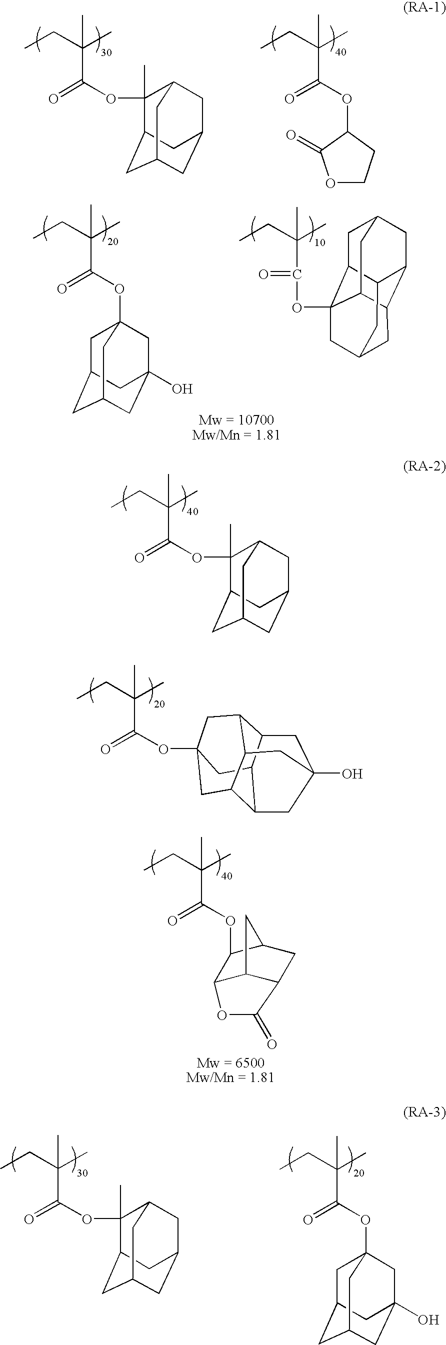

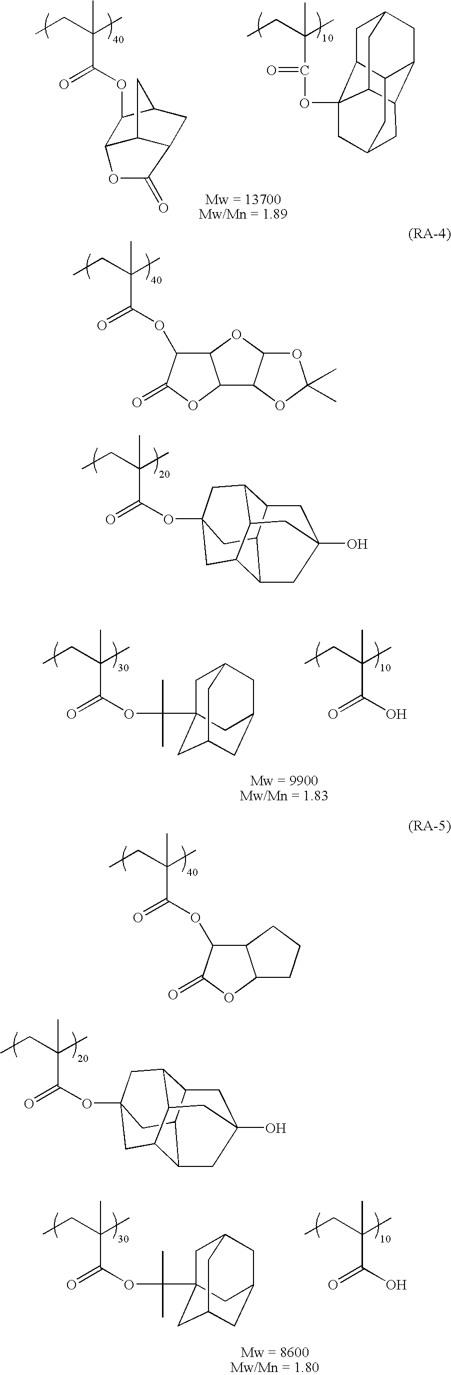

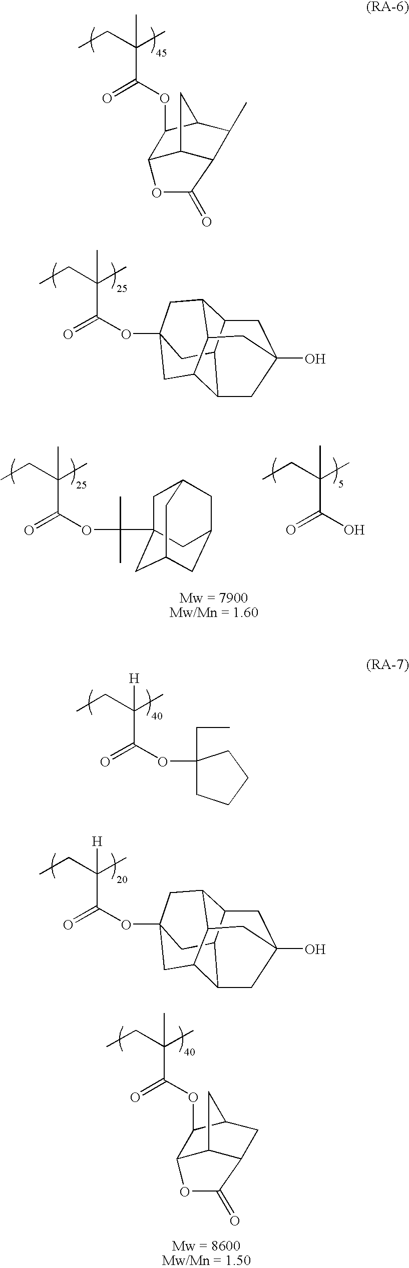

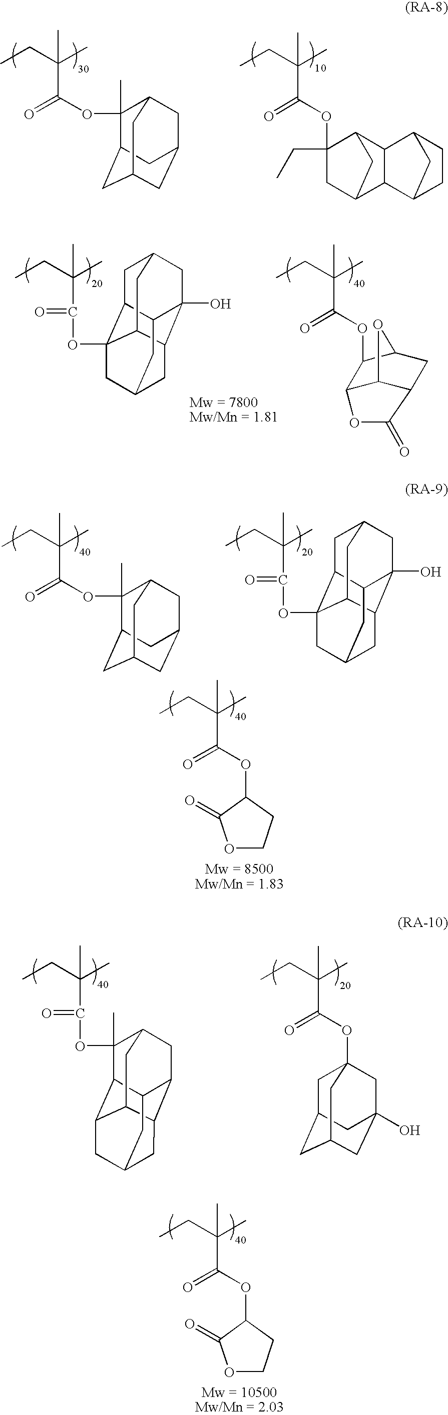

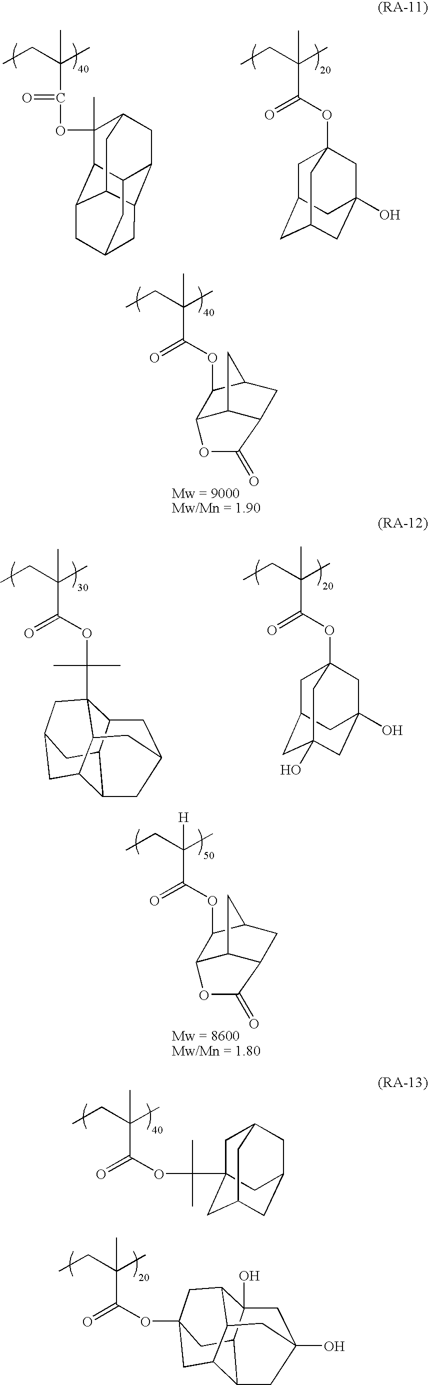

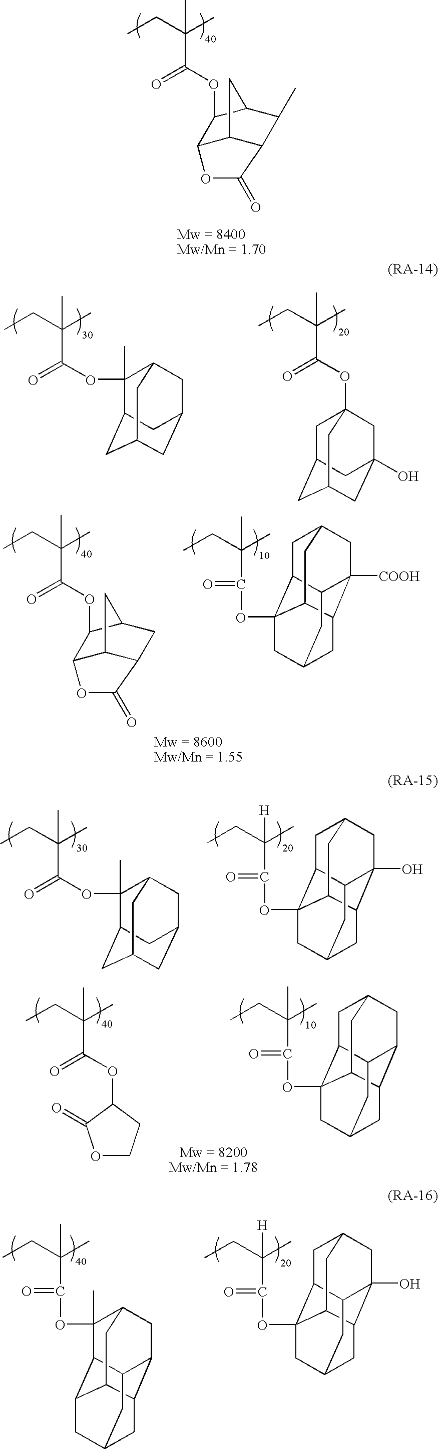

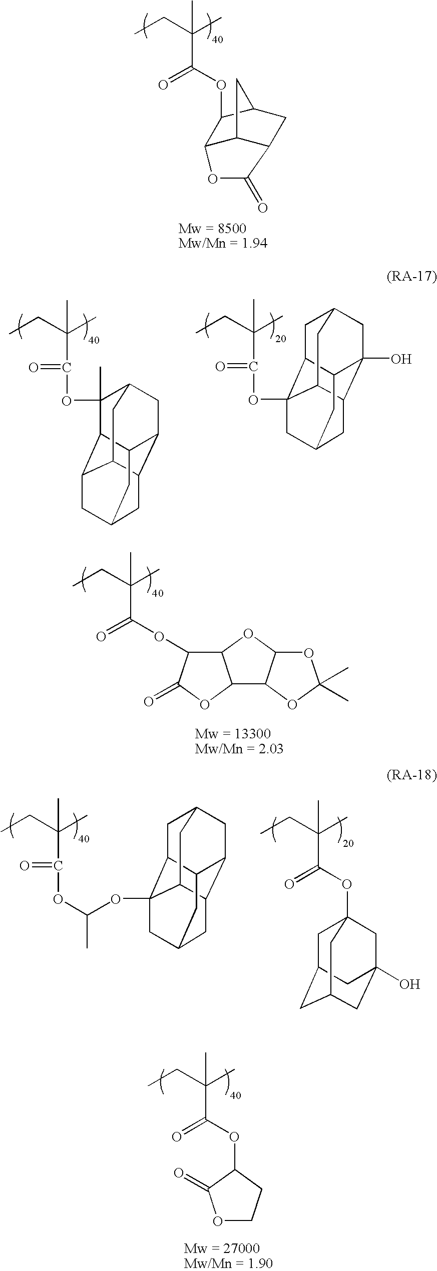

### Examples 1 to 21 and Comparative Examples 1 and 2

<Resist Preparation>

Each set of components shown in Table 1 was dissolved in the solvent to prepare a solution having a solid concentration of 9% by mass. This solution was filtered through a 0.03-μm polyethylene filter to prepare a positive resist solution. The positive resist solutions prepared were evaluated by the following methods. The results obtained are shown in Table 1.

TABLE 1

| | | | | | | | | Number |
|---|---|---|---|---|---|---|---|---|
| | Acid | | Basic | | Solvent | Pattern | Line edge | of |
| | generator | Resin | compound | Surfactant | (mass | falling | roughness | development |
| | (g) | (10 g) | (g) | (g) | ratio) | (nm) | (nm) | defects |
| Example | | | | | | | | |
| 1 | z2(0.3) | RA-1 | DIA(0.03) | W-4(0.01) | S1/S5 = 60/40 | 55 | 4.6 | 160 |
| 2 | z2(0.3) | RA-2 | TPA(0.05) | W-2(0.02) | S1/S4/S6 = 80/5/15 | 55 | 4.7 | 180 |
| 3 | z63(0.2) | RA-3 | HAP(0.02 | W-1(0.01) | S1/S6 = 95/5 | 55 | 4.9 | 150 |
| 4 | z23(0.3) | RA-4 | DIA(0.03) | W-4(0.01) | S1/S5 = 60/40 | 55 | 4.5 | 160 |
| 5 | z15(0.2) | RA-5 | PEA(0.03) | W-4(0.01) | S1/S5 = 80/20 | 55 | 4.6 | 170 |
| 6 | z2(0.2) | RA-6 | DIA(0.02) | W-4(0.01) | S1/S4/S6 = 80/5/15 | 55 | 4.7 | 140 |
| | z30(0.2) | | PEA(0.02) | | | | | |
| 7 | z16(0.3) | RA-7 | TMEA(0.03) | W-3(0.03) | S1/S5 = 60/40 | 60 | 5.2 | 200 |
| 8 | z55(0.3) | RA-8 | TBAH(0.04) | W-1(0.005) | S1/S6 = 80/20 | 55 | 4.6 | 180 |
| 9 | z51(0.5) | RA-9 | HEP(0.03) | W-3(0.02) | S1/S5 = 60/40 | 55 | 4.7 | 170 |
| 10 | z2(0.3) | RA-10 | TPSA(0.05) | W-3(0.01) | S1/S5 = 60/40 | 60 | 5.1 | 210 |
| 11 | z44(0.2) | RA-11 | DCMA(0.03) | W-4(0.01) | S1/S3 = 60/40 | 60 | 5.3 | 200 |
| 12 | z2(0.3) | RA-12 | DIA(0.03) | W-4(0.01) | S1/S5 = 60/40 | 60 | 5.3 | 190 |
| 13 | z23(0.4) | RA-13 | PEA(0.01) | W-2(0.02) | S1/S5 = 60/40 | 55 | 4.7 | 160 |
| 14 | z2(0.5) | RA-14 | PEA(0.04) | W-4(0.01) | S1/S3 = 60/40 | 55 | 4.5 | 180 |
| 15 | z23(0.1) | RA-15 | DIA(0.02) | W-2(0.02) | S1/S5 = 60/40 | 55 | 4.6 | 170 |
| | z46(0.3) | | PEA(0.02) | | | | | |
| 16 | z55(0.2) | RA-16 | DIA(0.02) | W-2(0.01) | S1/S3 = 60/40 | 60 | 5.2 | 190 |
| | z51(0.2) | | PEA(0.02) | | | | | |
| 17 | z23(0.2) | RA-17 | DIA(0.02) | W-4(0.01) | S1/S3 = 60/40 | 60 | 5.3 | 210 |
| | z55(0.4) | | PEA(0.02) | | | | | |
| 18 | z62(0.4) | RA-18 | DIA(0.02) | W-4(0.01) | S1/S5/S7 = 59/40/1 | 60 | 5.6 | 200 |
| | z65(0.1) | | PEA(0.02) | | | | | |
| 19 | z59(0.3) | RA-1 | DIA(0.02) | W-4(0.01) | S1/S5/S7 = 59/40/1 | 55 | 4.5 | 160 |
| | | (5 g) | PEA(0.02) | | | | | |
| | | RA-2 | | | | | | |
| | | (5 g) | | | | | | |
| 20 | z2(0.3) | RA-1 | DIA(0.03) | W-4(0.01) | S3 = 100 | 55 | 5.9 | 260 |
| 21 | z2(0.3) | RA-1 | DIA(0.03) | W-4(0.01) | S3/S4 = 95/5 | 55 | 6.0 | 280 |
| 22 | z2(0.3) | RA-1 | DIA(0.03) | W-4(0.01) | S1/S5 = 60/40 | 55 | 4.6 | 110 |
| | | (9 g) | | | | | | |
| | | B2-6* | | | | | | |
| | | (1 g) | | | | | | |
| Comparative | | | | | | | | |
| Example | | | | | | | | |
| 1 | z2(0.3) | RA-1′ | DIA(0.03) | W-4(0.01) | S1/S5 = 60/40 | 65 | 6.2 | 630 |
| 2 | z2(0.3) | RA-1″ | DIA(0.03) | W-4(0.01) | S1/S5 = 60/40 | 65 | 6.2 | 1020 |

*Weight-average molecular weight, 7,800

The abbreviations used in the table are as follows.

[Basic Compounds]

TPI: 2,4,5-triphenylimidazole

TPSA: triphenylsulfonium acetate

DIA: 2,6-diisopropylaniline

DCMA: dicyclohexylmethylamine

TPA: tripentylamine

HAP: hydroxyantipyrine

TBAH: tetrabutylammonium hydroxide

TMEA: tris(methoxyethoxyethyl)amine

PEA: N-phenyldiethanolamine

[Surfactants]

W-1: Megafac F176 (manufactured by Dainippon Ink & Chemicals, Inc.) (fluorochemical)

W-2: Megafac R08 (manufactured by Dainippon Ink & Chemicals, Inc.) (fluorochemical and silicone)

W-3: polysiloxane polymer KP-341 (manufactured by Shin-Etsu Chemical Co., Ltd.) (silicone)

W-4: Troysol S-366 (manufactured by Troy Chemical Co., Ltd.)

[Solvents]

S-1: propylene glycol methyl ether acetate

S-2: 2-heptanone

S-3: cyclohexanone

S-4: γ-butyrolactone

S-5: propylene glycol methyl ether

S-6: ethyl lactate

S-7: propylene carbonate

Antireflection film DUV-42, manufactured by Brewer Science, was applied in an even thickness of 600 Å with a spin coater to a silicon substrate treated with hexamethyldisilazane. The coating was dried at 100° C. for 90 seconds on a hot plate and then dried with heating at 190° C. for 240 seconds. Thereafter, each positive resist solution was applied thereto with a spin coater and dried at 110° C. for 90 seconds to form a 180-nm resist film. This resist film was exposed to light with an ArF excimer laser stepper (manufactured by ASML; NA=0.75; 2/3 zone illumination) through a mask. Immediately after the exposure, the resist film was heated on a hot plate at 120° C. for 90 seconds. Furthermore, the resist film was developed with a 2.38% by mass aqueous solution of tetramethylammonium hydroxide at 23° C. for 60 seconds, rinsed with pure water for 30 seconds, and then dried to obtain a line pattern.

Method of Evaluation for Pattern Falling:

The exposure amount necessary for reproducing a mask pattern comprising 80-nm lines and spaces in a ratio of 1:1 was taken as the optimal exposure amount.

The exposure amount was increased from the optimal exposure amount to form line patterns having reduced line widths, and the line width for the finest pattern which could be reproduced with satisfactory resolution without causing pattern falling was determined as a measure of unsusceptibility to pattern falling. The smaller the value, the finer the pattern which can be reproduced without falling. Namely, smaller values indicate that pattern falling is less apt to occur and resolution is higher.

Method of Evaluation for Line Edge Roughness:

Line edge roughness was examined in the following manner. An 80-nm line/space=1/1 pattern was examined with a length-measuring scanning electron microscope (SEM). In the line pattern, length-direction edges in a range of 5 μm were examined with the length-measuring SEM (S-8840, manufactured by Hitachi, Ltd.) to measure the distance from the standard line where each edge was to be present. This measurement was made on 50 points. A standard deviation was determined and 3σ was calculated. The smaller the value thereof, the better the performance.

Method of Evaluation for Development Defect:

Each positive resist solution was evenly applied with a spin coater to a 6-inch silicon substrate treated with hexamethyldisilazane. The coating was dried by heating on a hot plate at 120° C. for 90 seconds to form a 0.20-μm resist film. Without being exposed, this resist film was heated on a hot plate at 110° C. for 90 seconds. Furthermore, the resist film was developed with an aqueous tetramethylammonium hydroxide solution having a concentration of 2.38% by weight at 23° C. for 60 seconds, rinsed with pure water for 30 seconds, and then dried. The sample wafer thus obtained was examined with KLA 2112 (manufactured by KLA-Tencor Corp.) to count development defects (threshold, 12; pixel size=0.39).

It can be seen from Table 1 that the positive photosensitive compositions of the invention are excellent in development defect performance and improved in line edge roughness and pattern falling.

Immersion Exposure

<Resist Preparation>

The components for each of Examples 1 to 21 and Comparative Examples 1 and 2 shown in Table 1 were dissolved in the solvent to prepare a solution having a solid concentration of 7% by mass. This solution was filtered through a 0.03-μm polyethylene filter to prepare a positive resist solution. The positive resist solutions thus prepared were evaluated by the following method.

<Evaluation for Resolution>

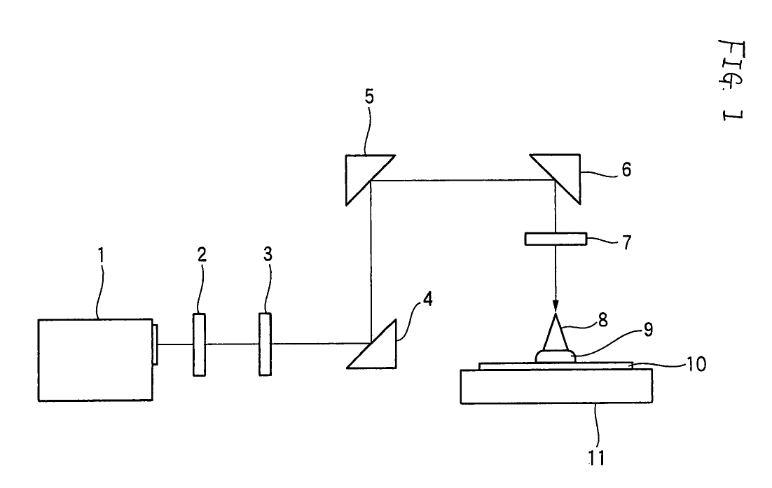

Organic antireflection film ARC29A (manufactured by Nissan Chemical Industries) was applied to a silicon wafer and backed at 205° C. for 60 seconds to form a 78-nm antireflection film. Each of the positive resist solutions was applied on the film and baked at 115° C. for 60 seconds to form a 150-nm resist film. The wafer thus obtained was subjected to two-beam interference exposure using pure water as an immersion liquid (wet exposure). As shown in FIG. 1, a laser 1, diaphragm 2, shutter 3, three reflecting mirrors 4, 5, and 6, and condensing lens 7 were used in the two-beam interference exposure (wet) to expose the wafer 10, which had the antireflection film and resist film, to light through a prism 8 and an immersion liquid (pure water) 9. The laser 1 used had a wavelength of 193 nm. The prism 8 used was one for forming a 65-nm line-and-space pattern. Immediately after the exposure, the resist film was heated at 115° C. for 90 seconds, subsequently developed with an aqueous tetramethylammonium hydroxide solution (2.38%) for 60 seconds, rinsed with pure water, and then spin-dried to obtain a resist pattern. This resist pattern was examined with a scanning electron microscope (S-9260, manufactured by Hitachi, Ltd.). In the case where the positive resist solutions of Examples 1 to 21 were used, 65-nm line-and-space patterns could be formed with satisfactory resolution without causing pattern falling. On the other hand, in the case where the positive resist solutions of Comparative Examples 1 and 2 were used, 65-nm line-and-space patterns could be formed with satisfactory resolution but pattern falling was observed in part of the patterns.

It is apparent that the positive photosensitive compositions of the invention have satisfactory image-forming ability even when used in exposure through an immersion liquid.

The invention can provide a positive photosensitive composition which, even when used in forming fine patterns of 100 nm or finer, is excellent in development defects and improved in line edge roughness and pattern falling. The invention can further provide a method of pattern formation with the composition.

The entire disclosure of each and every foreign patent application from which the benefit of foreign priority has been claimed in the present application is incorporated herein by reference, as if fully set forth.

What is claimed is:

1. A positive photosensitive composition comprising:
(A) a compound which generates an acid upon irradiation with actinic rays or a radiation;
(B) a resin which decomposes by an action of an acid to come to have an enhanced solubility in an alkaline developing solution; and
(F) a solvent,
wherein the resin as the component (B) is a resin that has a repeating unit (Ba) having a diamantane structure, and
wherein the resin as the component (B) has a weight-average molecular weight of from 3,000 to 30,000 and a dispersity ratio of from 1.1 to 3.0.

2. The positive photosensitive composition according to claim 1,
wherein the resin as the component (B) further has a repeating unit having an adamantane structure.

3. The positive photosensitive composition according to claim 1,
wherein the resin as the component (B) further has a non-acid-decomposable repeating unit.

4. The positive photosensitive composition according to claim 1,
wherein the solvent (F) comprises an alkylene glycol monoalkyl ether carboxylate.

5. The positive photosensitive composition according to claim 4,
wherein the solvent (F) further comprises at least one solvent selected from solvents having at least one functional group selected from a hydroxyl group, a ketone group, a lactone group, an ester group, an ether group and a carbonate group.

6. The positive photosensitive composition according to claim 5,
wherein the solvent (F) comprises: propylene glycol monomethyl ether acetate; and at least one solvent selected from propylene glycol monomethyl ether, cyclohexanone, γ-butyrolactone, butyl acetate and ethyl lactate.

7. The positive photosensitive composition according to claim 1,
wherein the resin as the component (B) is a resin synthesized by dropping polymerization.

8. The positive photosensitive composition according to claim 1,
wherein the compound which generates an acid upon irradiation with actinic rays or a radiation (A) is a compound represented by formula (ZI), (ZII) or (ZIII): 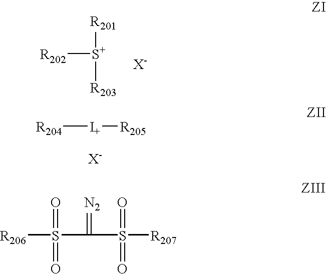
wherein R₂₀₁, R₂₀₂ and R₂₀₃ each independently represents an organic group;
X⁻ represents a non-nucleophilic anion; and
R₂₀₄ to R₂₀₇ each independently represents an aryl group, an alkyl group or a cycloalkyl group.

9. A method of pattern formation, which comprises:
forming a photosensitive film from a positive photosensitive composition according to claim 1;
exposing the photosensitive film to light, so as to form an exposed photosensitive film; and
developing the exposed photosensitive film.
